(19) United States
(12) Patent Application Publication
(10) Pub. No.: US 2013/0038642 A1
(43) Pub. Date: Feb. 14, 2013

(54) METHOD FOR DRIVING PLASMA DISPLAY DEVICE, PLASMA DISPLAY DEVICE, AND PLASMA DISPLAY SYSTEM

(71) Applicants: Takahiko Origuchi, Osaka (JP); Hirofumi Honda, Osaka (JP)

(72) Inventors: Takahiko Origuchi, Osaka (JP); Hirofumi Honda, Osaka (JP)

(73) Assignee: PANASONIC CORPORATION, Osaka (JP)

(21) Appl. No.: 13/643,058

(22) PCT Filed: Apr. 22, 2011
(86) PCT No.: PCT/JP2011/002354

§ 371 Date: Oct. 23, 2012

(30) Foreign Application Priority Data
Apr. 23, 2010 (JP) 2010-099473

(51) Int. Cl. G09G 5/10

(52) U.S. Cl. 345/690

(57) ABSTRACT

Crosstalk is reduced to provide a high quality of image display when displaying a stereoscopic image on a plasma display panel. For this purpose, there is provided a method for driving a plasma display apparatus which displays the image on the plasma display panel, by alternately repeating a field for right-eye displaying an image signal for right-eye and a field for left-eye displaying an image signal for left-eye. The method is such that, in a first field and a temporally consecutive second field, for a discharge cell where a gradation displayed in the occurring-temporally-later second field is not larger than a predetermined comparison value, when displaying a gradation not smaller than a predetermined threshold in the occurring-temporally-earlier first field, image data are set where address operation is prohibited in a last subfield of the first field.

### TECHNICAL FIELD

The present invention relates to a plasma display apparatus, a plasma display system, and a driving method of the plasma display apparatus that alternately displays, on a plasma display panel, an image for right-eye and an image for left-eye, which allows a user to view a stereoscopic image using a pair of shutter glasses.

### BACKGROUND ART

An AC surface-discharge panel, i.e. a typical plasma display panel (hereinafter, simply referred to as “panel”), is such that a large number of discharge cells are formed between a front substrate and a rear substrate which are arranged facing one another. The front substrate is such that a plurality of display electrode pairs in parallel with one another are formed on a glass substrate on the front side of the panel, with each of the pairs being composed of a scan electrode and a sustain electrode. A dielectric layer and a protective layer are formed to cover these display electrode pairs.

The rear substrate is such that a plurality of data electrodes in parallel with one another are formed on a glass substrate on the rear side of the panel, a dielectric layer is formed to cover these data electrodes, and a plurality of barrier ribs in parallel with the data electrodes are further formed on the dielectric layer. Phosphor layers are formed on the surface of the dielectric layer and on the side surfaces of the barrier ribs.

Then, the front substrate and the rear substrate are faced to one another and hermetically sealed such that the display electrode pairs intersect three-dimensionally with the data electrodes. In a discharge space in the hermetically-sealed inside, a discharge gas is enclosed which contains xenon at a partial pressure ratio of 5%, for example, and discharge cells are formed where the display electrode pairs are opposed to the data electrodes. With the thus configured panel, a gas discharge generates ultraviolet rays in each of the discharge cells, and the ultraviolet rays excite the phosphors of red color (R), green color (G), and blue color (B) so as to emit light for displaying a color image.

A method commonly used for driving the panel is a subfield method. In the subfield method, gradations are displayed by dividing one field into a plurality of subfields and causing light-emission or no light-emission for the respective discharge cells for each subfield. Each of the subfields includes an initializing period, an address period, and a sustain period.

In the initializing period, an initializing operation is performed in such a way that an initializing waveform is applied to the respective scan electrodes to cause an initializing discharge in the respective discharge cells. This operation forms wall charge necessary for a subsequent address operation in the respective discharge cells, and also generates priming particles (excitation particles that cause a discharge) for causing stable address discharges.

The initializing operation includes a forced initializing operation and a selective initializing operation. The forced initializing operation causes the initializing discharge in the respective discharge cells whatever operation in the immediately preceding subfield was. The selective initializing operation causes the initializing discharge only in the respective discharge cells in which address discharges occurred in the immediately preceding subfield.

In the address period, a scan pulse is sequentially applied to the scan electrodes, and an address pulse is applied selectively to the data electrodes in accordance with an image signal to be displayed. This operation causes the address discharges between the scan electrodes and the data electrodes of the discharge cells to be lit, and thereby forms wall charge in the discharge cells (hereinafter, these operations are also collectively referred to as “addressing”).

In the sustain period, sustain pulses corresponding in number to a luminance weight predetermined for each of the subfields are applied alternately to the display electrode pairs, i.e. alternately to the scan electrodes and the sustain electrodes that configure the pairs. This operation causes a sustain discharge in the respective discharge cells where the address discharges have occurred, and thereby causes the phosphor layers of the respective discharge cells to emit light (hereinafter, lighting of a discharge cell by a sustain discharge is referred to as “lighting”, and not lighting of a discharge cell is also referred to as “non-lighting”). With this configuration, each the discharge cell is caused to emit light at a luminance corresponding to the luminance weight. This light-emission of the phosphor layers caused by the sustain discharge is involved in gradation display, while light-emission accompanying the forced initializing operation is not involved in the gradation display.

In this manner, each of the discharge cells of the panel is lit at the luminance corresponding to a gradation value of the image signal, so that an image is displayed on an image display area of the panel.

One of the important factors in enhancing the quality of image display in the panel is an improvement in contrast. In this context, a driving method has been disclosed, as one of the subfield methods, in which contrast ratio is improved by minimizing light-emission not involved in gradation display so as to reduce luminance when displaying black, i.e. the lowest gradation.

In this driving method, the forced initializing operation is performed using a ramp waveform voltage which varies gently. Of the plurality of subfields configuring one field, the forced initializing operation is performed in the initializing period in one subfield, while the selective initializing operation is performed in the initializing periods in the other subfields. In this way, the number of performance of the forced initializing operation is reduced to one for one field.

Luminance of an area of displaying black where no sustain discharge occurs (hereinafter, simply referred to as “luminance of Hack level”) varies due to the light-emission not involved in the image display, such as the light-emission caused by the initializing discharge. In the above driving method, the light-emission of the area displaying black is reduced to be equal exclusively to weak light-emission that is caused by the initializing operation performed in all the discharge cells. This allows a reduced luminance of black level, resulting in high contrast of the displayed image (see Patent Literature 1, for example).

It has been examined to use a plasma display apparatus as a three-dimension (3D) image display apparatus which displays a 3D image capable of being stereoscopically viewed on the panel thereof.

One 3 D image is configured with one image for right-eye and one image for left-eye. This plasma display apparatus alternately displays the image for right-eye and the image for left-eye so as to display the 3D image on the panel.

For stereoscopic viewing of the thus-displayed 3D image on the panel, a user is required to view the image for right-eye only with user's right-eye and the image for left-eye only with user's left-eye. For this purpose, the user uses special glasses called “a pair of shutter glasses” to view the 3D image displayed on the panel.

The pair of shutter glasses includes a shutter for right-eye and a shutter for left-eye. In a period during which an image for right-eye is displayed on the panel, the right-eye shutter is opened (in a state of transmitting visible light) and the left-eye shutter is closed (in a state of blocking visible light). In a period during which an image for left-eye is displayed, the left-eye shutter is opened and the right-eye shutter is closed. In this way, the pair of shutter glasses alternately opens and closes the right-eye and left-eye shutters in synchronization respectively with fields that display the image for right-eye and fields displaying the image for left-eye.

This configuration allows the user to view the image for right-eye only with user's right-eye and to view the image for left-eye only with user's left-eye, resulting in the stereoscopic viewing of the 3D image displayed on the panel.

One 3D image is configured with one image for right-eye and one image for left-eye. That is, when 3D image are displayed, a half of the images displayed on the panel per unit time (e.g. per second) are the images for right-eye, and the remaining half of the images are the images for left-eye. Thus, the number of the 3D images displayed on the panel per second is a half of the field frequency (the number of fields displayed per second). When the number of images displayed on the panel per unit time decreases, flickering called flicker in the image is likely to be seen.

When displaying, on the panel, images other than 3D images, i.e. general images (hereinafter, referred to as “2D images”) where the image for right-eye and the image for left-eye are not discriminated, 60 images are displayed per second at a field frequency of 60 Hz on the panel, for example. Therefore, in order to display 3D images equal in number (e.g. 60 images per second) to 2D images on the panel per unit time, the field frequency of the 3D images needs to be set to twice (e.g. 120 Hz) the field frequency of 2D images.

The following method has been disclosed which is one of the methods for stereoscopically viewing a 3D image using a plasma display apparatus (see Patent Literature 2, for example). That is, a plurality of subfields are grouped into groups: one subfield group in which images for right-eye are displayed and the other subfield group in which images for left-eye are displayed. In each of the subfield groups, the shutters of a pair of shutter glasses are opened and closed in synchronization with the start of the address period of the first-occurring subfield of the group.

On the other hand, the phosphors used in the panel have afterglow characteristics depending on materials of the phosphors. This afterglow is a phenomenon in which a phosphor continues to emit light even after completion of a discharge. For example, there is a phosphor material that has characteristics of persistence of afterglow for several milliseconds after completion of a sustain discharge.

Therefore, for example, even after the period for displaying an image for right-eye (or an image for left-eye) has been completed, the image for right-eye (or the image for left-eye) is still displayed on the panel as an after-image, depending on afterglow time. The after-image is a phenomenon in which, even after completion of the period for displaying an image, the image still remains displayed on the panel. And, the afterglow time is a period of time during which the afterglow decreases sufficiently.

When an image for left-eye is displayed on the panel before the after-image of an image for right-eye has disappeared, a phenomenon occurs in which the image for right-eye is mixed into the image for left-eye. Similarly, when an image for right-eye is displayed on the panel before the after-image of an image for left-eye has disappeared, a phenomenon occurs in which the image for left-eye is mixed into the image for right-eye. Hereinafter, such a phenomenon is referred to as “crosstalk”. Such occurrence of crosstalk degrades the quality in three-dimensional effect of the 3D image.

### CITATION LIST

### Patent Literature

PTL 1
Japanese Patent Unexamined Publication No. 2000-242224

PTL 2
Japanese Patent Unexamined Publication No. 2000-112428

### SUMMARY OF THE INVENTION

The present method for driving a plasma display apparatus is as follows. The plasma display apparatus includes: a panel in which a plurality of discharge cells are arranged with each of the cells having a scan electrode, a sustain electrode, and a data electrode; and a driver circuit for driving the panel. The driving method is configured such that one field is formed of a plurality of subfields. Each of the subfields includes: an address period for addressing the discharge cells so as to cause address discharges in accordance with an image signal; and a sustain period for causing sustain discharges only in the discharge cells that have undergone the address discharges, with the number of the sustain discharges being in accordance with a luminance weight. In the driving method, image data are set which indicate light-emission or no light-emission for the respective discharge cells for each subfield in accordance with the image signal. An image is displayed on the panel by alternately repeating fields for right-eye in which an image signal for right-eye is displayed and fields for left-eye in which an image signal for left-eye is displayed, in accordance with the image signal including the image signal for right-eye and the image signal for left-eye. With this configuration, in the first field and the second field that are temporally consecutive, the image data are set as follows. For the respective discharge cells in which a gradation value displayed in the occurring-temporally-later second field is not larger than a predetermined comparison value, when displaying a gradation not smaller than a predetermined threshold in the occurring-temporally-earlier first field, the image data are set such that address operation is prohibited in the subfield occurring at the last of the first field.

With this configuration, it is possible to suppress crosstalk occurring between an image for right-eye and an image for left-eye, allowing display of a high quality 3D image on the panel.

The present method for driving a plasma display apparatus is as follows. The plasma display apparatus includes: a panel in which a plurality of discharge cells are arranged with each of the cells having a scan electrode, a sustain electrode, and a data electrode; and a driver circuit for driving the panel. The driving method is configured such that one field is formed of a plurality of subfields. Each of the subfields includes: an address period for addressing the discharge cells so as to cause address discharges in accordance with an image signal; and a sustain period for causing sustain discharges only in the discharge cells that have undergone the address discharges, with the number of the sustain discharges being in accordance with a luminance weight. In the driving method, image data are set which indicate light-emission or no light-emission for the respective discharge cells for each subfield in accordance with the image signal. An image is displayed on the panel by alternately repeating fields for right-eye in which an image signal for right-eye is displayed and fields for left-eye in which an image signal for left-eye is displayed, in accordance with the image signal including the image signal for right-eye and the image signal for left-eye. With this configuration, in the first field and the second field that are temporally consecutive, the image data are set as follows. For the respective discharge cells in which a gradation value displayed in the occurring-temporally-earlier first field is not larger than a predetermined comparison value, when displaying a gradation not smaller than a predetermined threshold in the occurring-temporally-later second field, the image data are set such that address operation is prohibited in the subfield occurring at the last of the second field.

With this configuration, it is possible to suppress the crosstalk occurring between the image for right-eye and the image for left-eye, allowing display of a high quality 3D image on the panel.

In the driving methods for the plasma display apparatus, the comparison value described above may be set to equal the magnitude of a gradation value of “0”.

In the driving methods for the plasma display apparatus, the image data may be set depending on types of the plurality of the discharge cells configuring a pixel, as follows. For a discharge cell having a phosphor exhibiting the longest afterglow time among others, the image data are set in accordance with a coding table in which the threshold described above is set. For a discharge cell having a phosphor exhibiting the shortest afterglow time, the image data are set in accordance with a coding table in which the threshold described above is not set.

In the driving methods for the plasma display apparatus, in the field for right-eye and the field for left-eye, the subfields thereof may be set in terms of luminance weight as follows. The first-occurring subfield of each the field is set to have the largest luminance weight, each of the second-occurring subfield and subsequent ones is set to have a sequentially decreasing luminance weight in ascending order of the subfields, and the last-occurring subfield is set to have the smallest luminance weight.

In the driving methods for the plasma display apparatus, in the field for right-eye and the field for left-eye, the subfields thereof may be set in terms of luminance weights as follows. The subfield occurring at the first of each the field is set as the subfield with the smallest luminance weight, the second-occurring subfield is set as the subfield with the largest luminance weight, and each of the third-occurring subfield and subsequent ones is set to have a sequentially decreasing luminance weight in ascending order of the subfields.

In the driving methods for the plasma display apparatus, the magnitude of the threshold described above may be changed in response to a brightness of the image displayed on the panel in such a way that the higher the brightness of the image is, the smaller the threshold is.

The present plasma display apparatus is as follows. The plasma display apparatus includes: a panel in which a plurality of discharge cells are arranged with each of the cells having a scan electrode, a sustain electrode, and a data electrode; and a driver circuit for driving the panel. The driver circuit causes one field to be formed of a plurality of subfields. Each of the subfields includes: an address period for addressing the discharge cells to cause address discharges in accordance with an image signal; and a sustain period for causing sustain discharges only in the discharge cells that have undergone the address discharges, with the number of the sustain discharges being in accordance with a luminance weight. The driver circuit sets image data which indicate light-emission or no light-emission for the respective discharge cells for each subfield in accordance with the image signal. And, the driver circuit provides the display of an image on the panel by alternately repeating fields for right-eye in which an image signal for right-eye is displayed and fields for left-eye in which an image signal for left-eye is displayed, in accordance with the image signal including the image signal for right-eye and the image signal for left-eye. With this configuration, in the first field and the second field that are temporally consecutive, the image data are set as follows. For the respective discharge cells in which a gradation value displayed in the occurring-temporally-later second field is not larger than a predetermined comparison value, when displaying a gradation not smaller than a predetermined threshold in the occurring-temporally-earlier first field, the image data are set such that address operation is prohibited in the subfield occurring at the last of the first field.

With this configuration, it is possible to suppress the crosstalk occurring between the image for right-eye and the image for left-eye, allowing display of a high quality 3D image on the panel.

The present plasma display apparatus is as follows. The plasma display apparatus includes: a panel in which a plurality of discharge cells are arranged with each of the cells having a scan electrode, a sustain electrode, and a data electrode; and a driver circuit for driving the panel. The driver circuit causes one field to be formed of a plurality of subfields. Each of the subfields includes: an address period for addressing the discharge cells to cause address discharges in accordance with an image signal; and a sustain period for causing sustain discharges only in the discharge cells that have undergone the address discharges, with the number of the sustain discharges being in accordance with a luminance weight. The driver circuit sets image data which indicate light-emission or no light-emission for the respective discharge cells for each subfield in accordance with the image signal. And, the driver circuit provides the display of an image on the panel by alternately repeating fields for right-eye in which an image signal for right-eye is displayed and fields for left-eye in which an image signal for left-eye is displayed, in accordance with the image signal including the image signal for right-eye and the image signal for left-eye. With this configuration, in the first field and the second field that are temporally consecutive, the image data are set as follows. For the respective discharge cells in which a gradation value displayed in the occurring-temporally-earlier first field is not larger than a predetermined comparison value, when displaying a gradation not smaller than a predetermined threshold in the occurring-temporally-later second field, the image data are set such that address operation is prohibited in the subfield occurring at the last of the second field.

With this configuration, it is possible to suppress the crosstalk occurring between the image for right-eye and the image for left-eye, allowing display of a high quality 3D image on the panel.

The present plasma display system includes a plasma display apparatus and a pair of shutter glasses. The plasma display apparatus includes a panel and a driver circuit for driving the panel. The panel includes a plurality of discharge cells arranged in the panel, with each of the discharge cells having a scan electrode, a sustain electrode, and a data electrode. The driver circuit includes a timing-signal output part that outputs a shutter opening/closing timing signal in synchronization with a field for right-eye and a field for left-eye. The pair of shutter glasses includes a right-eye shutter and a left-eye shutter, and both the shutters are, independently of each other, capable of being opened and closed, which is controlled by the shutter opening/closing timing signal. The driver circuit causes one field to be formed of a plurality of subfields. Each of the subfields includes: an address period for addressing the discharge cells so as to cause address discharges in accordance with an image signal; and a sustain period for causing sustain discharges only in the discharge cells that have undergone the address discharges, with the number of the sustain discharges being in accordance with a luminance weight. The driver circuit sets image data which indicate light-emission or no light-emission for the respective discharge cells for each subfield in accordance with the image signal. And, the driver circuit provides the display of an image on the panel by alternately repeating fields for right-eye in which an image signal for right-eye is displayed and fields for left-eye in which an image signal for left-eye is displayed, in accordance with the image signal including the image signal for right-eye and the image signal for left-eye. With this configuration, in the first field and the second field that are temporally consecutive, the image data are set as follows. For the respective discharge cells in which a gradation value displayed in the occurring-temporally-later second field is not larger than a predetermined comparison value, when displaying a gradation not smaller than a predetermined threshold in the occurring-temporally-earlier first field, the image data are set such that address operation is prohibited in the subfield occurring at the last of the first field.

With this configuration, it is possible to suppress the crosstalk occurring between the image for right-eye and the image for left-eye, allowing display of a high quality 3D image on the panel.

The present plasma display system includes a plasma display apparatus and a pair of shutter glasses. The plasma display apparatus includes a panel and a driver circuit for driving the panel. The panel includes a plurality of discharge cells arranged in the panel, with each of the discharge cells having a scan electrode, a sustain electrode, and a data electrode. The driver circuit includes a timing-signal output part that outputs a shutter opening/closing timing signal in synchronization with a field for right-eye and a field for left-eye. The pair of shutter glasses includes a right-eye shutter and a left-eye shutter, and both the shutters are, independently of each other, capable of being opened and closed, which is controlled by the shutter opening/closing timing signal. The driver circuit causes one field to be formed of a plurality of subfields. Each of the subfields includes: an address period for addressing the discharge cells so as to cause address discharges in accordance with an image signal; and a sustain period for causing sustain discharges only in the discharge cells that have undergone the address discharges, with the number of the sustain discharges being in accordance with a luminance weight. The driver circuit sets image data which indicate light-emission or no light-emission for the respective discharge cells for each subfield in accordance with the image signal. And, the driver circuit provides the display of an image on the panel by alternately repeating fields for right-eye in which an image signal for right-eye is displayed and fields for left-eye in which an image signal for left-eye is displayed, in accordance with the image signal including the image signal for right-eye and the image signal for left-eye. With this configuration, in the first field and the second field that are temporally consecutive, the image data are set as follows. For the respective discharge cells in which a gradation value displayed in the occurring-temporally-earlier first field is not larger than a predetermined comparison value, when displaying a gradation not smaller than a predetermined threshold in the occurring-temporally-later second field, the image data are set such that address operation is prohibited in the subfield occurring at the last of the second field.

With this configuration, it is possible to suppress the crosstalk occurring between the image for right-eye and the image for left-eye, allowing display of a high quality 3D image on the panel.

### BRIEF DESCRIPTION OF DRAWINGS

FIG. 1 is an exploded perspective view showing a structure of a panel used in a plasma display apparatus according to a first embodiment of the present invention.

FIG. 2 is an electrode array diagram of the panel used in the plasma display apparatus according to the first embodiment of the invention.

FIG. 3 shows a schematic circuit block diagram of the plasma display apparatus and a schematic diagram outlining a plasma display system according to the first embodiment of the invention.

FIG. 4 is a chart schematically showing driving voltage waveforms applied to respective electrodes of the panel used in the plasma display apparatus according to the first embodiment of the invention.

FIG. 5 is a waveform chart schematically showing driving voltage waveforms applied to the respective electrodes of the panel used in the plasma display apparatus and showing opening/closing operation of a pair of shutter glasses according to the first embodiment of the invention.

FIG. 6 is a table showing one example of a coding table serving as a base when displaying a 3D image in the plasma display apparatus according to the first embodiment of the invention.

FIG. 7A is a table showing one example of a coding table used when displaying a 3D image in the plasma display apparatus according to the first embodiment of the invention.

FIG. 7B is a table showing another example of a coding table used when displaying a 3D image in the plasma display apparatus according to the first embodiment of the invention.

FIG. 7C is a table showing further another example of a coding table used when displaying a 3D image in the plasma display apparatus according to the first embodiment of the invention.

FIG. 8 is a diagram schematically showing a part of an image signal processing circuit used in the plasma display apparatus according to the first embodiment of the invention.

FIG. 9 is a diagram schematically showing a part of an image signal processing circuit used in a plasma display apparatus according to a second embodiment of the invention.

### DESCRIPTION OF EMBODIMENTS

Hereinafter, a description will be made of a plasma display apparatus and a plasma display system according to embodiments of the present invention, with reference to the drawings.

### First Exemplary Embodiment

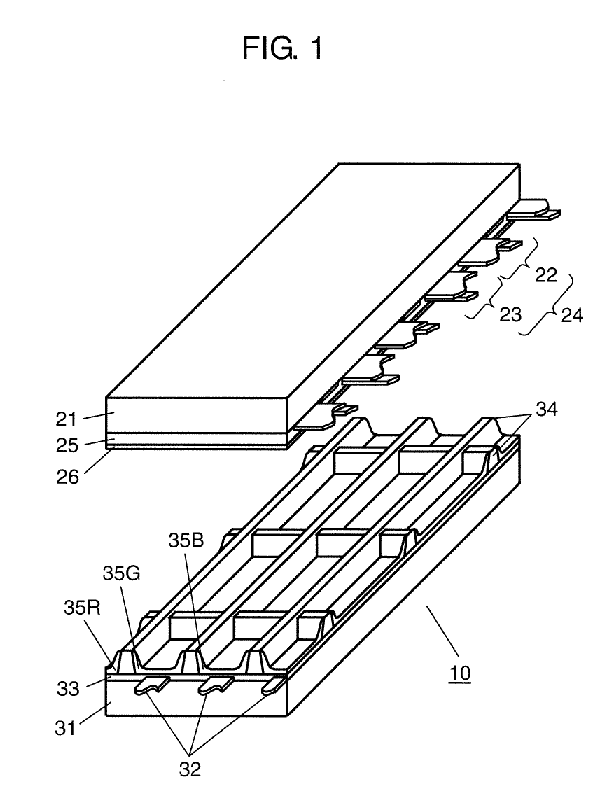

FIG. 1 is an exploded perspective view showing a structure of panel 10 used in a plasma display apparatus according to a first embodiment of the present invention. A plurality of display electrode pairs 24, each of which is composed of scan electrode 22 and sustain electrode 23, are formed on front substrate 21 made of glass. Dielectric layer 25 is formed to cover scan electrodes 22 and sustain electrodes 23. And, on dielectric layer 25, protective layer 26 is formed.

Protective layer 26 is formed of a material majorly composed of magnesium oxide (MgO) so as to reduce discharge start voltages in discharge cells. The MgO is a time-proven material for use in panels and shows a large secondary electron emission coefficient and excellent durability provided that neon (Ne) and xenon (Xe) gases are sealed.

On rear substrate 31, a plurality of data electrodes 32 are formed. Dielectric layer 33 is formed to cover data electrodes 32. On top of the dielectric layer, barrier ribs 34 of a hanging-rack shape are formed. On dielectric layer 33 and the side walls of barrier ribs 34, phosphor layers are disposed which are phosphor layer 35R for emitting light of red color (R), phosphor layer 35G for emitting light of green color (G), and phosphor layer 35B for emitting light of blue color (B). Hereinafter, these phosphor layer 35R, phosphor layer 35G, and phosphor layer 35B are also collectively referred to as phosphor layer 35.

In the embodiment, the blue phosphor is BaMgAl₁₀O₁₇:Eu, the green phosphor is Zn₂SiO₄:Mn, and the red phosphor is (Y,Gd)BO₃:Eu. However, the phosphors forming phosphor layer 35 according to the present invention are not limited to these phosphors described above.

A time constant, with which afterglow of a phosphor decays, varies depending on materials of the phosphors, i.e. 1 msec or less for the blue phosphor, approximately 2 msec to 5 msec for the green phosphor, and approximately 3 msec to 4 msec for the red phosphor. For example, in the embodiment, the time constant for phosphor layer 35B is approximately 0.1 msec, and those for phosphor layer 35G and phosphor layer 35R are approximately 2 msec to 3 msec. The time constant is defined as a period of time which the luminance of afterglow requires to decay from a peak to 10% of the peak after finishing a discharge, with the peak being the luminance (peak luminance) of emission light during the discharge.

These front substrate 21 and rear substrate 31 are disposed to face one another via a small discharge space such that display electrode pairs 24 intersect data electrodes 32. Then, outer peripheries of these substrates are sealed with a sealing material such as a glass frit. In the discharge space inside the sealed substrates, a mixed gas of neon and xenon, for example, is enclosed as a discharge gas.

The discharge space is partitioned into a plurality of sections by barrier ribs 34 such that the discharge cells are formed at intersections of display electrode pairs 24 and data electrodes 32.

In these discharge cells, discharges occur so as to cause phosphor layers 35 of the discharge cells to emit light (to light the discharge cells), so that a color image is displayed on panel 10.

In panel 10, one pixel is configured with three consecutive discharge cells, i.e. a discharge cell for emitting light of red color (R), a discharge cell for emitting light of green color (G), and a discharge cell for emitting light of blue color (B). These cells are arranged in the direction in which display electrode pairs 24 extend.

The structure of panel 10 is not limited to that described above. For example, rear substrate 31 may be one including barrier ribs of a stripe shape.

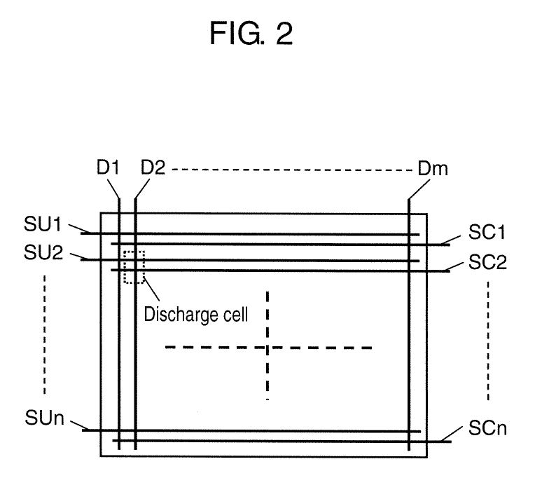

FIG. 2 is an electrode array diagram of panel 10 used in the plasma display apparatus according to the first embodiment of the invention. In panel 10, there are arranged n-lines of scan electrode SC1 to scan electrode SCn (scan electrodes 22 of FIG. 1) and n-lines of sustain electrode SU1 to sustain electrode SUn (sustain electrodes 23 of FIG. 1), with both electrodes extending in the horizontal direction (row direction). And, there are arranged m-lines of data electrode D1 to data electrode Dm (data electrodes 32 of FIG. 1), with the data electrodes extending in the vertical direction (column direction). Thus, each of the discharge cells is formed at the area where a pair of scan electrode SCi (i=1 to n) and sustain electrode SUi intersects one data electrode Dj (j=1 to m). That is, for one pair of display electrode 24, m-units of the discharge cells are formed to configure m/3 pixels. The m×n units of discharge cells are formed in the discharge space, and the area having the thus-formed m×n discharge cells is then the image display area of panel 10. For example, for a panel with 1920×1080 pixels, m=1920×3 and n=1080.

For example, a red phosphor is applied as phosphor layers 35R to the discharge cells having data electrode Dp (p=3×q−2 where q is an integer equal to m/3 or less except 0), a green phosphor is applied as phosphor layers 35G to the discharge cells having data electrode Dp+1, and a blue phosphor is applied as phosphor layers 35B to the discharge cells having data electrode Dp+2.

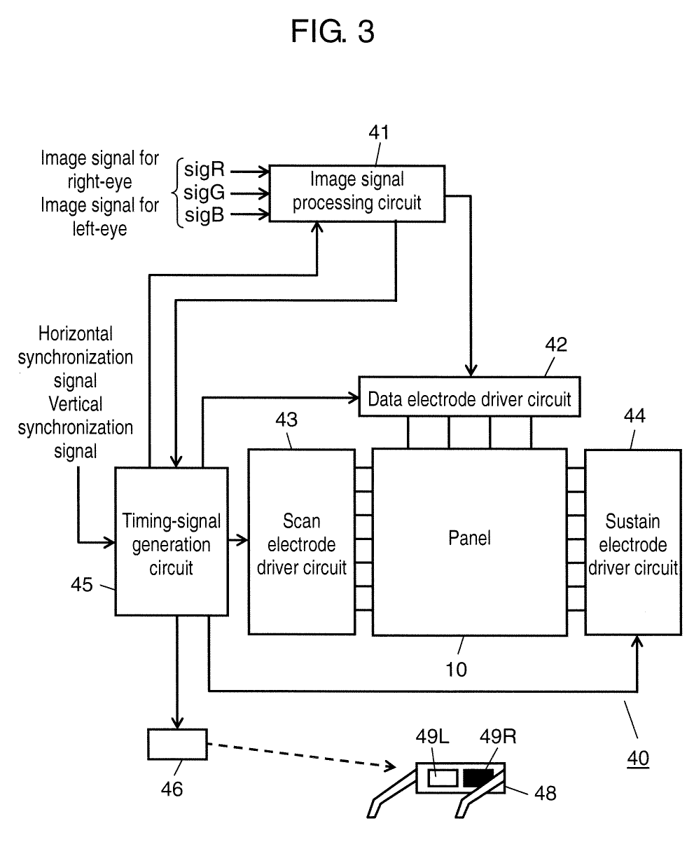

FIG. 3 shows a schematic circuit block diagram of plasma display apparatus 40 and a schematic diagram outlining a plasma display system according to the first embodiment of the invention. The plasma display system shown in the embodiment includes plasma display apparatus 40 and a pair of shutter glasses 48 as elements thereof.

Plasma display apparatus 40 includes: panel 10 in which a plurality of the discharge cells are arranged, with each the cell having scan electrode 22, sustain electrode 23, and data electrode 32; and a driver circuit for driving panel 10. The driver circuit includes image signal processing circuit 41, data electrode driver circuit 42, scan electrode driver circuit 43, sustain electrode driver circuit 44, timing-signal generation circuit 45, and a power supply circuit (not shown) for supplying required power to the respective circuit blocks.

The driver circuit drives panel 10 in any one of a 3D-driving mode and a 2D-driving mode. In the 3D-driving, a 3D image is displayed on panel 10 by alternately repeating a field for right-eye and a field for left-eye in accordance with a 3D image signal. In the 2D driving, a 2D image is displayed on panel 10 in accordance with a 2D image signal without discrimination between fields for right-eye and for left-eye.

The plasma display system according to the embodiment includes plasma display apparatus 40 and the pair of shutter glasses 48. Then, plasma display apparatus 40 includes timing-signal output part 46 that outputs a shutter opening/closing timing signal to the pair of shutter glasses 48 so as to control opening and closing of shutters of the pair of shutter glasses 48.

The pair of shutter glasses 48 is used by a user, when displaying a 3D image on panel 10, in such a way that the user views the 3D image displayed on panel 10 through the pair of shutter glasses 48, which allows the user to stereoscopically view the 3D image.

Image signal processing circuit 41 receives the 2D image signal or the 3D image signal, and allocates gradation values for the respective discharge cells in accordance with the received image signal. Then, the image signal processing circuit converts the gradation values into image data which indicate light-emission or no light-emission (data in which light-emission and no light-emission correspond respectively to digital signals “1” and “0”) for each subfield. That is, image signal processing circuit 41 converts the image signal into the image data that indicate light-emission or no light-emission for each subfield, for every field.

The image signal, inputted to image signal processing circuit 41, is red primary color signal sigR, green primary color signal sigG, and blue primary color signal sigB. Image signal processing circuit 41 allocates a gradation value of each of R, G, and B to the respective discharge cells in accordance with primary color signal sigR, primary color signal sigG, and primary color signal sigB. When the input image signals include a luminance signal (Y signal) and a chroma signal (a C signal, an R-Y signal and a B-Y signal, or a u-signal and a v-signal, or the like), image signal processing circuit 41 calculates primary color signal sigR, primary color signal sigG, and primary color signal sigB in accordance with the luminance signal and the chroma signal. After that, the processing circuit allocates a gradation value (a gradation value to be represented in one field) of each of R, G, and B to the respective discharge cells. Then, the processing circuit converts the gradation values of R, G, and B, allocated to the respective discharge cells, into the image data that indicate light-emission or no light-emission for each subfield.

In the case where the input image signal is the 3D image signal for stereoscopic viewing and includes an image signal for right-eye and an image signal for left-eye, when displaying the 3D image signal on panel 10, the image signal for right-eye and the image signal for left-eye are alternately inputted to image signal processing circuit 41 for every field. Image signal processing circuit 41 converts the image signal for right-eye into image data for right-eye, and converts the image signal for left-eye into image data for left-eye.

Timing-signal generation circuit 45 determines which of the 2D image signal and the 3D image signal is inputted to plasma display apparatus 40, in accordance with the input signal. Then, based on the resulting judgment, the circuit generates timing signals to control operation of the respective circuit blocks so as to display the 2D image or the 3D image on panel 10.

Specifically, timing-signal generation circuit 45 determines whether the signal inputted to plasma display apparatus 40 is the 3D image signal or the 2D image signal, based on frequencies of a horizontal synchronization signal and a vertical synchronization signal of the input signal. For example, the circuit determines that the input signal is the 2D image signal when the horizontal synchronization signal is at 33.75 kHz and the vertical synchronization signal is at 60 Hz. The circuit determines that the input signal is the 3D image signal when the horizontal synchronization signal is at 67.5 kHz and the vertical synchronization signal is at 120 Hz.

Then, timing-signal generation circuit 45 generates various kinds of timing signals to control the operation of the respective circuit blocks, based on the horizontal synchronization signal and the vertical synchronization signal. The thus-generated timing signals are fed to the respective circuit blocks (data electrode driver circuit 42, scan electrode driver circuit 43, sustain electrode driver circuit 44, image signal processing circuit 41, and so on).

To timing-signal output part 46, timing-signal generation circuit 45 outputs the shutter opening/closing timing signal for controlling the opening and closing of the shutters of the pair of shutter glasses 48, when displaying the 3D image on panel 10. Timing-signal generation circuit 45 sets the shutter opening/closing timing signal to ON (“1”) so as to open the shutter of shutter glasses 48 (in a state of transmitting visible light), and sets the shutter opening/closing timing signal to OFF (“0”) so as to close the shutter of shutter glasses 48 (in a state of blocking visible light).

The shutter opening/closing timing signal includes: a timing signal for right-eye (a timing signal for opening/closing the shutter for right-eye), and a timing signal for left-eye (a timing signal for opening/closing the shutter for left-eye). The timing signal for right-eye is set to ON when the field for right-eye is displayed on panel 10 in accordance with the image signal for right-eye of the 3D image, and is set to OFF when the field for left-eye is displayed in accordance with the image signal for left-eye of the 3D image. In contrast, the timing signal for left-eye is set to ON when the field for left-eye is displayed in accordance with the image signal for left-eye of the 3D image, and is set to OFF when the field for right-eye is displayed in accordance with the image signal for right-eye of the 3D image.

In the embodiment, the frequencies of the horizontal synchronization signal and the vertical synchronization signal are not limited to those values described above. In the case where a discriminant signal is added to the input signal so as to discriminate between the 2D image signal and the 3D image signal, timing-signal generation circuit 45 may be configured to determine which of the 2D image signal and the 3D image signal is being inputted, based on the discriminant signal.

Scan electrode driver circuit 43 includes an initializing waveform generation circuit, a sustain pulse generation circuit, and a scan pulse generation circuit (not shown in FIG. 3). The scan electrode driver circuit generates driving voltage waveforms in accordance with the timing signals fed from timing-signal generation circuit 45, and applies the generated driving voltage waveforms to each of scan electrode SC1 to scan electrode SCn. The initializing waveform generation circuit generates initializing waveforms to be applied to scan electrode SC1 to scan electrode SCn in accordance with the timing signals, in an initializing period. The sustain pulse generation circuit generates sustain pulses to be applied to scan electrode SC1 to scan electrode SCn in accordance with the timing signals, in a sustain period. The scan pulse generation circuit which includes a plurality of scan electrode driver ICs (scan ICs), generates scan pulses to be applied to scan electrode SC1 to scan electrode SCn in accordance with the timing signals, in an address period.

Sustain electrode driver circuit 44 includes a sustain pulse generation circuit and a circuit (not shown in FIG. 3) for generating voltage Ve1 and voltage Ve1. The sustain electrode driver circuit generates driving voltage waveforms in accordance with the timing signals fed from timing-signal generation circuit 45, and applies the generated driving voltage waveforms to each of sustain electrode SU1 to sustain electrode SUn. In the sustain period, the sustain electrode driver circuit generates the sustain pulses in accordance with the timing signals, and applies the generated sustain pulses to sustain electrode SU1 to sustain electrode SUn.

Data electrode driver circuit 42 converts data for each of the subfields into signals corresponding to each of data electrode D1 to data electrode Dm, with the data for each of the subfields being ones which configure the image data, i.e. the image data in accordance with the 2D image signal, or the image data for right-eye and the image data for left-eye in accordance with the 3D image signal. Then, in accordance with the thus-converted signals and the timing signals fed from timing-signal generation circuit 45, the data electrode driver circuit drives each of data electrode D1 to data electrode Dm. In the address period, the data electrode driver circuit generates and applies an address pulse to each of data electrode D1 to data electrode Dm.

Timing-signal output part 46 includes a light-emitting element such as a light-emitting diode (LED), and feeds the shutter opening/closing timing signal to the pair of shutter glasses 48, with the timing signals being converted into infrared signals, for example.

The pair of shutter glasses 48 includes a signal receiver (not shown) for receiving signals (e.g. infrared signals) fed from timing-signal output part 46, and right-eye shutter 49R and left-eye shutter 49L. Right-eye shutter 49R and left-eye shutter 49L are each capable of being opened and closed, independently of each other. The pair of shutter glasses 48 opens and closes right-eye shutter 49R and left-eye shutter 49L in accordance with the shutter opening/closing timing signal fed from timing-signal output part 46.

Right-eye shutter 49R is opened (for transmitting visible light) when the timing signal for right-eye is ON, and is closed (for blocking visible light) when the timing signal for right-eye is OFF. Left-eye shutter 49L is opened (for transmitting visible light) when the timing signal for left-eye is ON, and is closed (for blocking visible light) when the timing signal for left-eye is OFF.

Right-eye shutter 49R and left-eye shutter 49L are configured using, for example, liquid crystals; however, in the present invention, materials configuring the shutters are not limited to the liquid crystals. The shutters may be configured using any material which is capable of switching between blocking and transmitting of visible light at high speed.

Next, an outline of the driving voltage waveforms for driving panel 10 and operation thereof will be described.

Plasma display apparatus 40 according to the embodiment is such that panel 10 is driven by a subfield method. In the subfield method, one field is divided into a plurality of subfields on a time base, and a luminance weight is set for each of the subfields. Thus, each of the fields includes the plurality of the subfields. Each of the subfields includes the initializing period, the address period, and the sustain period. An image is displayed on panel 10 by controlling light-emission and no light-emission of the respective discharge cells, for each subfield.

The luminance weight is one which represents a ratio of magnitudes of luminance displayed in each subfield. For each subfield, the sustain pulses corresponding in number to the luminance weight are generated in the sustain period. For example, the luminance of light-emission in the subfield with a luminance weight of “8” is approximately eight times higher than that in the subfield with a luminance weight of “1”, and is approximately four times higher than that in the subfield with a luminance weight of “2”. Accordingly, it is possible to display various gradations on panel 10 through a combination, in accordance with the image signals, of the subfields having various luminance weights, with each of the subfields selectively emitting light. This allows the display of the image.

In the embodiment, the image signal inputted to plasma display apparatus 40 is the image signal for stereoscopic viewing which alternately repeats the image signal for right-eye and the image signal for left-eye, for every field. Thus, the field for right-eye displaying the image signal for right-eye and the field for left-eye displaying the image signal for left-eye are alternately repeated in the display on panel 10, thereby allowing the display of the image (3D image) on panel 10 for stereoscopic viewing, with the image being composed of the image for right-eye and the image for left-eye.

Therefore, the number of the 3D images displayed in unit time (e.g. one second) is equal to a half of the field frequency (the number of fields occurring in one second). For example, when the field frequency is 60 Hz, each of the numbers of the images for right-eye and the images for left-eye displayed is 30 in one second; therefore, 30 of the 3D images are displayed in one second. Hence, in the embodiment, the field frequency is set to twice (e.g. 120 Hz) the common field frequency so as to reduce flickering (flicker) in the images, with the flicker being likely to be seen in images displayed at low field frequencies.

The user views the 3D image displayed on panel 10 through the pair of shutter glasses 48 which opens and closes right-eye shutter 49R and left-eye shutter 49L, independently of each other, in synchronization with the field for right-eye and the field for left-eye. This configuration allows the user to view the image for right-eye only with user's right-eye and to view the image for left-eye only with user's left-eye, resulting in the stereoscopic viewing of the 3D image displayed on panel 10.

A difference between the field for right-eye and the field for left-eye are only in the image signal to be displayed; therefore, the other configurations of these fields are identical regarding such as the number of the subfields which form one field, the luminance weight of each subfield, and an arrangement of the subfields. Then, in the case where there is no need for discrimination between “for right-eye” and “for left-eye”, the field for right-eye and the field for left-eye are each simply referred to as the field, hereinafter. Similarly, the image signal for right-eye and the image signal for left-eye are each simply referred to as the image signal. The configuration of a field is also referred to as the subfield configuration.

First, a description is made regarding the configuration of one field and the driving voltage waveforms to be applied to each electrode. Each of the field for right-eye and the field for left-eye includes a plurality of the subfields. Each of the subfields includes the initializing period, the address period, and the sustain period.

In the initializing period, initializing operation is performed in which initializing discharges occur in the discharge cells, and wall charge is formed on each of the electrodes, with the wall charge being necessary for address discharges in the subsequent address period. The initializing operation includes a forced initializing operation and a selective initializing operation. The forced initializing operation causes the initializing discharge in the respective discharge cells whatever operation in the immediately preceding subfield was. The selective initializing operation selectively causes the initializing discharge only in the respective discharge cells in which address discharges occurred in the address period of the immediately preceding subfield and sustain discharges occurred in the sustain period of the immediately preceding subfield.

In the forced initializing operation, a up-ramp waveform voltage and a down-ramp waveform voltage are applied to scan electrodes 22 so as to cause the initializing discharges in all the discharge cells in the image display area. Then, of the plurality of the subfields, the forced initializing operation is performed in the initializing period of one subfield, and the selective initializing operation is performed in the initializing periods of the other subfields. Hereinafter, the initializing period in which the forced initializing operation is performed is referred to as the “forced initializing period”, and the subfield having the forced initializing period is referred to as the “forced initializing subfield”. Similarly, the initializing period in which the selective initializing operation is performed is referred to as the “selective initializing period”, and the subfield having the selective initializing period is referred to as the “selective initializing subfield”.

In the address period, address operation is performed in such a way that the address pulse is applied selectively to data electrodes 32, with scan pulses being applied to scan electrodes 22, so as to selectively cause address discharges only in the discharge cells to be lit. The address discharges form wall charge in the thus-addressed discharge cells so as to cause sustain discharges in the subsequent sustain period.

In the sustain period, the sustain pulses are applied alternately to scan electrodes 22 and sustain electrodes 23, with the number of the sustain pulses being equal to the number of the luminance weight for each subfield multiplied by a predetermined proportional constant. It is the proportional constant that is a luminance magnification. For example, in the sustain period of a subfield with a luminance weight of “2”, when the luminance magnification is twice, the sustain pulse is applied four times to each of scan electrodes 22 and sustain electrodes 23. Thus, the number of the sustain pulses generated in the sustain period is eight. Then, the sustain discharges occur only in the discharge cells in which the address discharges occurred in the immediately preceding address period, so that the discharge cells are lit. Such operation in which sustain pulses are applied to discharge cells to light the cells, is the sustain operation.

In the embodiment, the image signal inputted to plasma display apparatus 40 is the 2D image signal or the 3D image signal. Thus, plasma display apparatus 40 drives panel 10 in accordance with any one of the image signals. Hereinafter, a description is made regarding the driving voltage waveforms which are applied to the respective electrodes of panel 10 when the 3D image signal is inputted to plasma display apparatus 40.

In the embodiment, an exemplary case is described in which one field is configured with five subfields (subfield SF1, subfield SF2 . . . and subfield SF5).

In the embodiment, only the first subfield (the subfield occurring at the first of a field) of each field is set as the forced initializing subfield. That is, the forced initializing operation is performed in the initializing period of the first subfield (subfield SF1), the selective initializing operation is performed in the initializing periods of the other subfields. With this configuration, the initializing discharges in all the discharge cells occur at least once in one field, which allows stabilization of the address operation performed after the forced initializing operation. Light-emission not involved in the image display is only light-emission associated with the discharges in the forced initializing operation in subfield SF1. Accordingly, luminance of black level, i.e. luminance of the area where black is displayed by not causing sustain discharges, is only a weak light-emission caused by the forced initializing operation, which allows the display of the image of high contrast on panel 10.

The subfields have luminance weights of (16, 8, 4, 2, and 1) respectively. In this way, the subfields are set in the embodiment, as follows. Subfield SF1 occurring at the first of a field is set as the subfield with the largest luminance weight, each of the second subfield (the subfield occurring at the second of a field) and subsequent ones is set to have a sequentially decreasing luminance weight in ascending order of the subfields, and subfield SF5 occurring at the last of the field is set as the subfield with the smallest luminance weight. The reason for the setting of luminance weights in this way will be described later.

In the embodiment, the number of subfields configuring one field and the luminance weights of the respective subfields are not limited to those described above. The configuration of a field may be one in which the configuration of subfields thereof is changed in accordance with the image signal or the like.

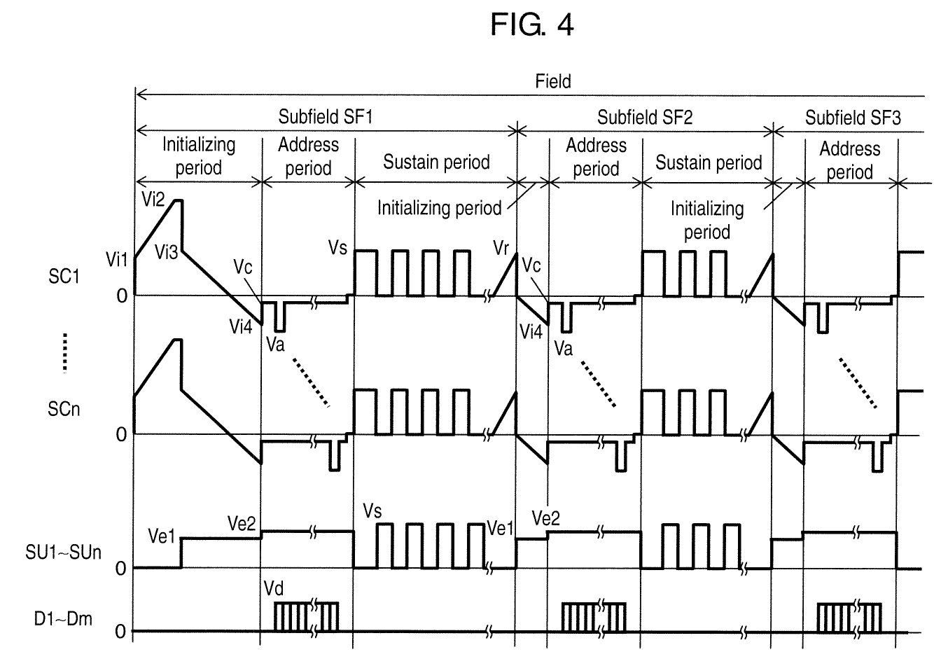

FIG. 4 is a chart schematically showing the driving voltage waveforms applied to the respective electrodes of panel 10 used in the plasma display apparatus according to the first embodiment of the invention. In FIG. 4, there are shown the driving voltage waveforms that are respectively applied to the electrodes, i.e. scan electrode SC1 that performs address operation at the first of an address period, scan electrode SCn that performs address operation at the end of the address period, sustain electrode SU1 to sustain electrode SUn, and data electrode D1 to data electrode Dm. Hereinafter, each of scan electrode SCi, sustain electrode SUi, and data electrode Dk represents the electrode selected from the respective electrodes in accordance with the image data (i.e. the data indicating light-emission or no light-emission for each subfield).

FIG. 4 shows the driving voltage waveforms majorly in two subfields: subfield SF1 and subfield SF2.

Subfield SF1 is one in which the forced initializing operation is performed, and subfield SF2 is one in which the selective initializing operation is performed. Therefore, subfield SF1 and subfield SF2 are different from each other in waveform of the driving voltages applied to scan electrodes 22 in the respective initializing periods. In the other subfields, their driving voltage waveforms are approximately the same as those in subfield SF2 except the number of the sustain pulses occurring in the respective sustain periods.

First, subfield SF1 serving as a forced initializing subfield is described.

In the first half of the initializing period of subfield SF1 that performs the forced initializing operation, a voltage of zero (V) is applied to each of data electrode D1 to data electrode Dm, and sustain electrode SU1 to sustain electrode SUn. Voltage Vi1 is applied to scan electrode SC1 to scan electrode SCn, and then a ramp waveform voltage is applied that gradually increases from voltage Vi1 to voltage Vi2. Voltage Vi1 is set to a voltage lower than a discharge start voltage, with respect to sustain electrode SU1 to sustain electrode SUn. Voltage Vi2 is set to a voltage exceeding the discharge start voltage, with respect to sustain electrode SU1 to sustain electrode SUn.

While the ramp waveform voltage increases, weak initializing discharges continuously occur between scan electrode SC1 to scan electrode SCn and sustain electrode SU1 to sustain electrode SUn, and between scan electrode SC1 to scan electrode SCn and data electrode D1 to data electrode Dm. Then, wall voltages of negative polarity are accumulated on scan electrode SC1 to scan electrode SCn, and wall voltages of positive polarity are accumulated on data electrode D1 to data electrode Dm and sustain electrode SU1 to sustain electrode SUn. These wall voltages on the electrodes represent voltages that are caused by wall charge accumulated on such as the dielectric layers covering the electrodes, the protective layer, and the phosphor layers.

In the last half of the initializing period of subfield SF1, voltage Ve1 of positive polarity is applied to sustain electrode SU1 to sustain electrode SUn, and a voltage of zero (V) is applied to data electrode D1 to data electrode Dm. To scan electrode SC1 to scan electrode SCn, a ramp waveform voltage is applied that gradually decreases from voltage Vi3 to voltage Vi4 of negative polarity. Voltage Vi3 is set to a voltage lower than the discharge start voltage, with respect to sustain electrode SU1 to sustain electrode SUn. Voltage Vi4 is set to a voltage exceeding the discharge start voltage, with respect to sustain electrode SU1 to sustain electrode SUn.

While the ramp waveform voltage is applied to scan electrode SC1 to scan electrode SCn, weak initializing discharges occur between scan electrode SC1 to scan electrode SCn and sustain electrode SU1 to sustain electrode SUn, and between scan electrode SC1 to scan electrode SCn and data electrode D1 to data electrode Dm. Then, there are reduced the wall voltages of negative polarity on scan electrode SC1 to scan electrode SCn and the wall voltages of positive polarity on sustain electrode SU1 to sustain electrode SUn. Meanwhile, the wall voltages of positive polarity on data electrode D1 to data electrode Dm are adjusted to those appropriate for the address operation.

In the manner described above, the initializing operation is completed in the initializing period of subfield SF1, that is the forced initializing operation which forcibly causes the initializing discharges in all the discharge cells.

In the subsequent address period of subfield SF1, voltage Ve2 is applied to sustain electrode SU1 to sustain electrode SUn, and voltage Vc is applied to each of scan electrode SC1 to scan electrode SCn.

Next, a negative scan pulse of voltage Va of negative polarity is applied to scan electrode SC1 in the first row to be first addressed. An address pulse of voltage Vd of positive polarity is applied to data electrode Dk that corresponds to the discharge cell to be lit in the first row of data electrode D1 to data electrode Dm.

In the discharge cell to which the address pulse of voltage Vd is applied, the voltage difference between data electrode Dk and scan electrode SC1 at the intersection thereof is then the sum of the voltage differences, i.e. the externally-applied-voltage difference (voltage Vd−voltage Va) and the voltage difference between the wall voltage on data electrode Dk and the wall voltage on scan electrode SC1. With this configuration, the voltage difference between data electrode Dk and scan electrode SC1 exceeds the discharge start voltage to cause a discharge between data electrode Dk and scan electrode SC1.

Since voltage Ve2 is applied to sustain electrode SU1 to sustain electrode SUn, the voltage difference between sustain electrode SU1 and scan electrode SC1 is then the sum of the voltage differences, i.e. the externally-applied-voltage difference (voltage Ve2−voltage Va) and the voltage difference between the wall voltage on sustain electrode SU1 and the wall voltage on scan electrode SC1. In this situation, voltage Ve2 can be set to a voltage slightly lower than the discharge start voltage such that the state between sustain electrode SU1 and scan electrode SC1 is made to be one in which a discharge does not occur, but is easy to occur.

With this configuration, the discharge caused between data electrode Dk and scan electrode SC1 can induce a discharge between sustain electrode SU1 and scan electrode SC1 in the area where both electrodes intersect data electrode Dk. Thus, the address discharge occurs in the discharge cell (the discharge cell to be lit) to which the scan pulse and the address pulse are applied simultaneously, the wall voltage of positive polarity is accumulated on scan electrode SC1, the wall voltage of negative polarity is accumulated on sustain electrode SU1, and the wall voltage of negative polarity is accumulated on data electrode Dk as well.

In this way, the address operation for accumulating the wall voltage on each of the electrodes is performed by causing the address discharge in the discharge cells to be lit in the first row. On the other hand, the voltage at the intersection between scan electrode SC1 and data electrode 32 to which no address pulse has been applied, does not exceed the discharge start voltage; therefore, no address discharge is caused there.

Next, the address operation in the discharge cell in the second row is performed in such a way that an address pulse is applied to data electrode Dk corresponding to the discharge cell to be lit in the second row, a scan pulse is applied to scan electrode SC2 in the second row.

Such address operation described above is sequentially performed until the operation reaches the discharge cells in the n-th row, in the order of scan electrode SC2, scan electrode SC3 . . . and scan electrode SCn. Thus, the address period of subfield SF1 is completed. In this way, in the address period, address discharges are selectively caused in the discharge cells to be lit, so that wall charge is formed in the discharge cells.

In the subsequent sustain period of subfield SF1, first, a sustain pulse of voltage Vs of positive polarity is applied to scan electrode SC1 to scan electrode SCn, a voltage of zero (V) is applied to sustain electrode SU1 to sustain electrode SUn.

By applying this sustain pulse, in each of the discharge cells in which the address discharges have occurred, the voltage difference between scan electrode SCi and sustain electrode SUi is the sum of voltage Vs of the sustain pulse and the voltage difference between the wall voltage on scan electrode SCi and the wall voltage on sustain electrode SUi.

With this configuration, the voltage differences between scan electrode SCi and sustain electrode SUi exceed the discharge start voltage to cause the sustain discharge between scan electrode SCi and sustain electrode SUi. Then, the sustain discharge emits ultraviolet light that causes phosphor layer 35R, phosphor layer 35G, and phosphor layer 35B to emit light. With the sustain discharge, the wall voltages of negative polarity are accumulated on scan electrode SCi, and the wall voltages of positive polarity are accumulated on sustain electrode SUi. The wall voltage of positive polarity is accumulated on data electrode Dk as well. In the discharge cells in which address discharges have not occurred in the address period, no sustain discharge occurs, so that the wall voltages at the end of the initializing period are held.

Subsequently, a sustain pulse of voltage Vs is applied to sustain electrode SU1 to sustain electrode SUn, a voltage of zero (V) is applied to scan electrode SC1 to scan electrode SCn. In the discharge cells in which the immediately preceding sustain discharges have occurred, the voltage differences between sustain electrode SUi and scan electrode SCi exceed the discharge start voltage. Thereby, the sustain discharges occur again between sustain electrode SUi and scan electrode SCi, phosphor layers 35 emit light in the discharge cells in which the sustain discharges occur, the wall voltages of negative polarity are accumulated on sustain electrode SUi, and the wall voltages of positive polarity are accumulated on scan electrode SCi.

Similarly, the sustain pulses are alternately applied to scan electrode SC1 to scan electrode SCn and sustain electrode SU1 to sustain electrode SUn, with the number of the sustain pulses being equal to the number of the luminance weight multiplied by a predetermined luminance magnification. In this way, by providing the voltage differences between the electrodes of each of display electrode pairs 24, the sustain discharges continuously occur in the discharge cells in which the address discharges occurred in the address period.

Then, after the generation of the sustain pulses in the sustain period (at the end of the sustain period), a ramp waveform voltage that gradually increases from a voltage of zero (V) to voltage Vr is applied to scan electrode SC1 to scan electrode SCn, while the voltage of zero (V) remains being applied to sustain electrode SU1 to sustain electrode SUn and data electrode D1 and data electrode Dm.

While the ramp waveform voltage applied to scan electrode SC1 to scan electrode SCn increases exceeding the discharge start voltage, a weak discharge continuously occurs in each of the discharge cells in which the sustain discharges have occurred. Charged particles generated by the weak discharge are accumulated on sustain electrode SUi and scan electrode SCi such that the voltage differences are moderated between sustain electrode SUi to scan electrode SCi. Thereby, the wall voltages on scan electrode SCi and sustain electrode SUi are reduced while the wall voltage of positive polarity on data electrode Dk remains as it is; that is, unnecessary wall charge in the discharge cell is erased.

After the voltage applied on scan electrode SC1 to scan electrode SCn has reached voltage Vr, the voltage applied on scan electrode SC1 to scan electrode SCn decreases to a voltage of zero (V). Thus, the sustain operation in the sustain period of subfield SF1 is completed.

With the above operation, subfield SF1 is completed.

In the initializing period of subfield SF2 for performing the selective initializing operation, the selective initializing operation is performed by applying to each electrode a driving voltage waveform which is the same as that in the initializing period of subfield SF1, with the waveform in the first half of the initializing period being omitted.

In the initializing period of subfield SF2, voltage Ve1 is applied to sustain electrode SU1 to sustain electrode SUn, and a voltage of zero (V) is applied to data electrode D1 to data electrode Dm. To scan electrode SC1 to scan electrode SCn, a ramp waveform voltage is applied that gradually decreases to voltage Vi4 of negative polarity from a voltage (e.g. a voltage of zero (V)) lower than the discharge start voltage. Voltage Vi4 is set to a voltage exceeding the discharge start voltage, with respect to sustain electrode SU1 to sustain electrode SUn.

While the ramp waveform voltage is applied to scan electrode SC1 to scan electrode SCn, weak initializing discharges occur in the discharge cells in which the sustain discharges occurred in the sustain period of the immediately preceding subfield (subfield SF1, in FIG. 4). Then, the weak initializing discharges can reduce the wall voltages on scan electrode SCi and sustain electrode SUi. An excessively sufficient amount of the wall voltage of positive polarity was accumulated on data electrode Dk by the sustain discharges caused in the sustain period of the immediately preceding subfield. The excessive amount of the wall voltage on data electrode Dk is discharged such that the wall voltage on data electrode Dk is adjusted to be appropriate for address operation.

In the discharge cells in which the sustain discharges did not occur in the sustain period in the immediately preceding subfield (subfield SF1), no initializing discharge occurs, so that the wall voltages at the end of the initializing period of the immediately preceding subfield are held.

In this way, the initializing operation in subfield SF2 is the selective initializing operation in which the initializing discharges are selectively caused in the discharge cells in which the address operation was performed in the address period of the immediately preceding subfield, i.e. in the discharge cells in which the sustain discharges occurred in the sustain period of the immediately preceding subfield.

With the above operation, the initializing operation, i.e. the selective initializing operation, in the initializing period of subfield SF2 is completed.

In the address period of subfield SF2, the address operation is performed in which the same driving voltage waveform as that in the address period of subfield SF1 is applied to each of the electrodes, so that a wall voltage is accumulated on each the electrode of the respective discharge cells to be lit.

In the subsequent sustain period, in a similar way to the sustain period of subfield SF1, the sustain discharges occur in the discharge cells in which the address discharges occurred in the address period. The sustain discharges occur in such a way that the sustain pulses are alternately applied to scan electrode SC1 to scan electrode SCn and sustain electrode SU1 to sustain electrode SUn, with the number of the sustain pulses being in accordance with the luminance weight.

In the initializing period and the address period of each of subfield SF3 and subsequent ones, the same driving voltage waveforms as those in the initializing period and the address period of subfield SF2 are applied to each of the electrodes. In the sustain period of each of subfield SF3 and subsequent ones, the same driving voltage waveforms as those in subfield SF2 except the number of the sustain pulses generated in the sustain period, are applied to each of the electrodes.

The configuration described above is the outline of the driving voltage waveforms applied to each of the electrodes of panel 10 according to the embodiment.

The voltages applied to the respective electrodes in the embodiment are set as follows: voltage Vi1=145 (V); voltage Vi2=335 (V); voltage Vi3=190 (V); voltage Vi4=−160 (V); voltage Va=−180 (V); voltage Vc=−35 (V); voltage Vs=190 (V); voltage Vr=190 (V); voltage Ve1=125 (V); voltage Ve2=130 (V); and voltage Vd=60 (V), for example. Voltage Vc is generated by using a superposition (Vc=Va+Vscn) of voltage Va=−180 (V) of negative polarity with voltage Vscn=145 (V) of positive polarity, and then Vc=−35 (V) in this case.

In the initializing period of subfield SF1, the up-ramp waveform voltage applied to scan electrode SC1 to scan electrode SCn is set to have a gradient of 1.5 (V/μsec), the down-ramp waveform voltage is set to have a gradient of −2.5 (V/μsec). In the initializing period of subfield SF2 to subfield SF5, the down-ramp waveform voltage applied to scan electrode SC1 to scan electrode SCn is set to have a gradient of −2.5 (V/μsec). After the generation of the sustain pulses in the sustain period (at the end of the sustain period), the up-ramp waveform voltage applied to scan electrode SC1 to scan electrode SCn is set to have a gradient of 10 (V/μsec).

The specific numerical values described above such as the voltages and the gradients of the ramp waveform voltages are only examples; therefore, each of the voltages and the gradients according to the present invention is not limited to the numerical values described above. Each of the voltages and the gradients is preferably optimally set based on discharge characteristics of the panel, specifications of the plasma display apparatus, and the like.

Plasma display apparatus 40 according to the embodiment is such that, when driving panel 10 in accordance with a 2D image signal, one field is configured with eight subfields (subfield SF1, subfield SF2 . . . subfield SF8), and subfield SF1 to subfield SF8 are set to have luminance weights (1, 2, 4, 8, 16, 32, 64, and 128) respectively. In the respective subfields, driving voltage waveforms applied to the respective electrodes are the same as those when displaying a 3D image signal on panel 10, except the number of sustain pulses generated in sustain periods; therefore, a description is omitted of operation of driving panel 10 in accordance with the 2D image signal.

Next, a description is made regarding the driving voltage waveforms applied to the respective electrodes of panel 10 when a 3D image signal is inputted to plasma display apparatus 40, in relation to the opening/closing operation of the shutters of the pair of shutter glasses 48.

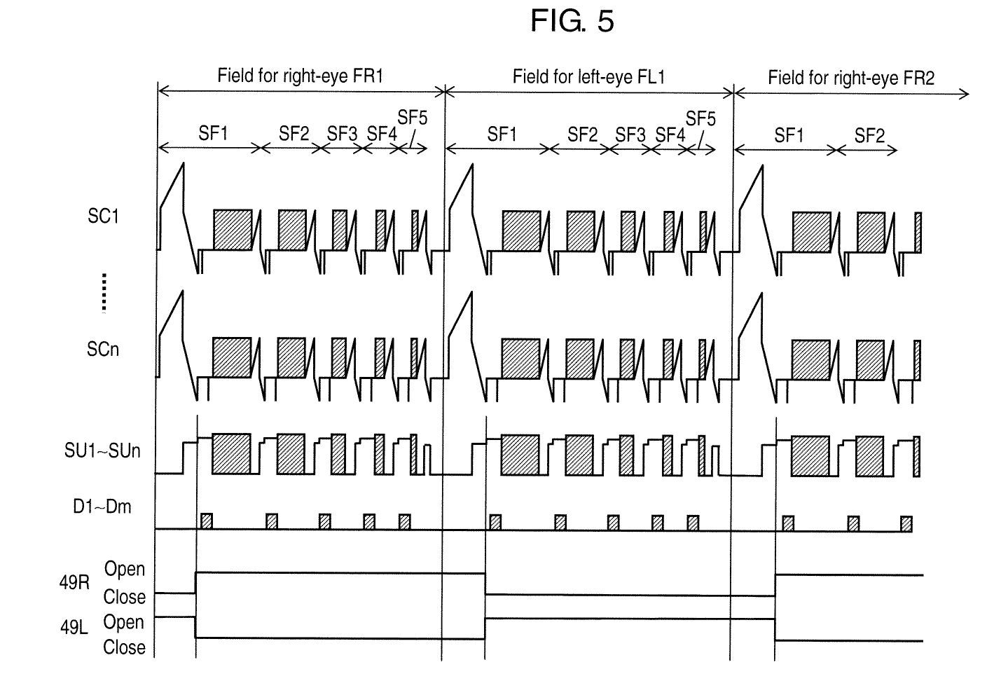

FIG. 5 is a waveform chart schematically showing the driving voltage waveforms applied to the respective electrodes of panel 10 used in plasma display apparatus 40 and showing the opening/closing operation of the pair of shutter glasses 48 according to the first embodiment of the invention.

In FIG. 5, there are shown the driving voltage waveforms that are respectively applied to scan electrode SC1 that performs the address operation at the first of an address period, scan electrode SCn that performs the address operation at the end of the address period, sustain electrode SU1 to sustain electrode SUn, and data electrode D1 to data electrode Dm. FIG. 5 shows the opening/closing operation of right-eye shutter 49R and left-eye shutter 49L.

The 3D image signal is an image signal for stereoscopic viewing, in which the image signal for right-eye and the image signal for left-eye are alternately repeated for every field. When the 3D image signal is inputted, plasma display apparatus 40 alternately repeats a field for right-eye in which the image for right-eye is displayed and a field for left-eye in which the image for left-eye is displayed, so that the apparatus alternately displays on panel 10 the image for right-eye and the image for left-eye. For example, of the three fields shown in FIG. 5, field FR1 and field FR2 are fields for right-eye in which the image signal for right-eye is displayed on panel 10. Field FL1 is a field for left-eye in which the image signal for left-eye is displayed on panel 10. In this way, plasma display apparatus 40 displays on panel 10 the 3D image for stereoscopic viewing which is configured with the image for right-eye and the image for left-eye.

A user viewing the 3D image displayed on panel 10 through the pair of shutter glasses 48, is able to recognize the images (the image for right-eye and the image for left-eye) as one stereoscopic image, with the images being subsequently displayed in two successive fields on a time basis. Hence, the user observes that the number of the 3D image displayed on panel 10 per unit time (e.g. one second) is a half of the field frequency (the number of fields displayed per second).

For example, when the field frequency (the number of fields displayed per second) of the 3D image displayed on the panel is 60 Hz, the numbers of the images for right-eye and the images for left-eye displayed on panel 10 are each 30 in one second; therefore, the user observes 30 of the 3D images in one second. For this reason, in order to display 60 of the 3D images in one second, the field frequency must be set to 120 Hz, i.e. twice as much as 60 Hz. Hence, in the embodiment, in an attempt to provide the user with smooth viewing of moving 3D images, the field frequency is set to twice (e.g. 120 Hz) the common field frequency so as to reduce flickering (flicker) in the images, with the flicker being likely to be seen in images displayed at low field frequencies.

Each of the field for right-eye and the field for left-eye includes five subfields (subfield SF1, subfield SF2, subfield SF3, subfield SF4, and subfield SF5). Subfield SF1 to subfield SF5 are set to have luminance weights (16, 8, 4, 2, and 1,) respectively. The forced initializing operation is performed in the initializing period of the subfield occurring at the first of a field, the selective initializing operation is performed in the initializing periods of the other subfields of the field.

The right-eye shutter 49R and the left-eye shutter 49L of the pair of shutter glasses 48 are controlled in opening/closing the shutters, in accordance with ON/OFF of the shutter opening/closing timing signal that is output from timing-signal output part 46 and is received by the pair of shutter glasses 48, as follows.

The pair of shutter glasses 48 opens the right-eye shutter 49R in synchronization with the start of the address period of subfield SF1 of field FR1 for right-eye, and closes the right-eye shutter 49R in synchronization with the start of the address period of subfield SF1 of field FL1 for left-eye. The pair of shutter glasses 48 opens the left-eye shutter 49L in synchronization with the start of the address period of subfield SF1 of field FL1 for left-eye, and closes the left-eye shutter 49L in synchronization with the start of the address period of subfield SF1 of field FR2 for right-eye.

Accordingly, in the pair of shutter glasses 48, the left-eye shutter 49L is closed in a period during which the right-eye shutter 49R is opened, the right-eye shutter 49R is closed in a period during which the left-eye shutter 49L is opened.

Thus, the user views the 3D image displayed on panel 10 through the pair of shutter glasses 48 that opens and closes the right-eye shutter 49R and the left-eye shutter 49L, independently of each other, in synchronization with the field for right-eye and the field for left-eye. With the configuration, the user can observe the image for right-eye only with user's right-eye and observe the image for left-eye only with user's left-eye, which allows the stereoscopic viewing of the 3D image displayed on panel 10.

In the embodiment, when displaying a 3D image signal on panel 10, the subfield having the largest luminance weight is generated at the first of a field, each of the subsequently generated subfields is set to have a sequentially decreasing luminance weight in ascending order of the subfields, and the subfield having the smallest luminance weight is generated at the last of the field. That is, each of the subfields configuring one field is sequentially decreased in luminance weight in temporal order of generation of the subfields, so that the later each of the subfields is generated, the smaller the luminance weight of the subfield is. In the embodiment, the thus-configured field allows a reduction in a leak of light-emission from the image for right-eye into the image for left-eye and in a leak of light-emission from the image for left-eye into the image for right-eye (hereinafter, such a phenomenon is referred to as “crosstalk”). This configuration is capable of providing a high-quality stereoscopic image for the user viewing the 3D image through the pair of shutter glasses 48. The reason for this is described hereinafter.

Phosphor layer 35 used in panel 10 has afterglow characteristics depending on materials forming the phosphor thereof. This afterglow is a phenomenon in which a phosphor continues to emit light even after completion of a discharge. The intensity of the afterglow is in proportion to the luminance of light-emission of the phosphor, and the higher the luminance of light-emission of the phosphor, the stronger the afterglow is. The afterglow decays with a time constant associated with characteristics of the phosphor, thereby decreasing gradually in luminance with time. There even exists a phosphor having characteristics that the afterglow thereof persists for several msec after completion of a sustain discharge. As the luminance of light-emission of the phosphor increases, a period of time increases that is required until the afterglow decays to a sufficient level.

Light-emission generated in the subfield having a larger luminance weight is higher in luminance than that in the subfield having a smaller luminance weight. Therefore, the afterglow of the light-emission generated in the subfield having a large luminance weight exhibits high luminance and a long period of time required for decay of the afterglow, compared with that generated in the subfield having a small luminance weight.

For this reason, the amount of a leak of the afterglow into the subsequent field increases when the last subfield (the subfield occurring at the last of a field) of one field is set to be a subfield having a large luminance weight, compared with when the last subfield is set to be one having a small luminance weight.

In plasma display apparatus 40 that displays a 3D image on panel 10 by alternately generating the field for right-eye and the field for left-eye, when afterglow generated in one field leaks into the subsequent field, the afterglow can be observed by the user as an unnecessary light-emission not involved in the image signal. Such the phenomenon is crosstalk.

Therefore, as the amount of the leak of the afterglow from one field into the subsequent one increases, the crosstalk deteriorates to impair the stereoscopic viewing of the 3D image, which results in degraded quality of image display in plasma display apparatus 40. The quality of image display in this context is the quality for the user viewing the 3D image through the pair of shutter glasses 48.

A reduction of the crosstalk by decreasing the afterglow leaking from one field into the subsequent one can be achieved as follows. A subfield having a large luminance weight is caused to occur in the early time in the one field such that the strong afterglow converges as much as possible within the field, and also the last subfield of the field is set to a subfield having a small luminance weight, which allows the lowest possible amount of the afterglow leaking into the subsequent field.

That is, in order to suppress the crosstalk when displaying a 3D image signal on panel 10, it is preferable to reduce the afterglow leaking into the subsequent field as much as possible in such a way as follows. The subfield having the largest luminance weight is generated at the first of a field, each of the subsequently generated subfields is set to have a sequentially decreasing luminance weight in ascending order of the subfields, and the subfield having the smallest luminance weight is generated at the last of the field.

This is the reason for setting each of the subfields to have a decreasing luminance weight in temporal order of generation of the subfields, in the plurality of the subfields configuring one field. In the embodiment, the number of subfields configuring one field and the luminance weights of the respective subfields are not limited to those described above. For example, the configuration may be as follows. Subfield SF1 is set to have the smallest luminance weight, subfield SF2 is set to have the largest luminance weight, each of subfield SF3 and subsequent ones is set to have a sequentially decreasing luminance weight in ascending order of the subfields, and the last subfield in the field is set to have the second smallest luminance weight or the same luminance weight as that of subfield SF1.

Next, in the embodiment, a method of displaying a gradation when displaying a 3D image signal on panel 10 is described. Hereinafter, a relation between a gradation value to be displayed and presence/absence of address operation in the subfield associated with the gradation is referred to as “coding”, and a set of coding is referred to as a “coding table”.

Hereinafter, a description is made under the assumption that one field is configured with five subfields, and that subfield SF1 to subfield SF5 are respectively set to have luminance weights (16, 8, 4, 2, and 1).

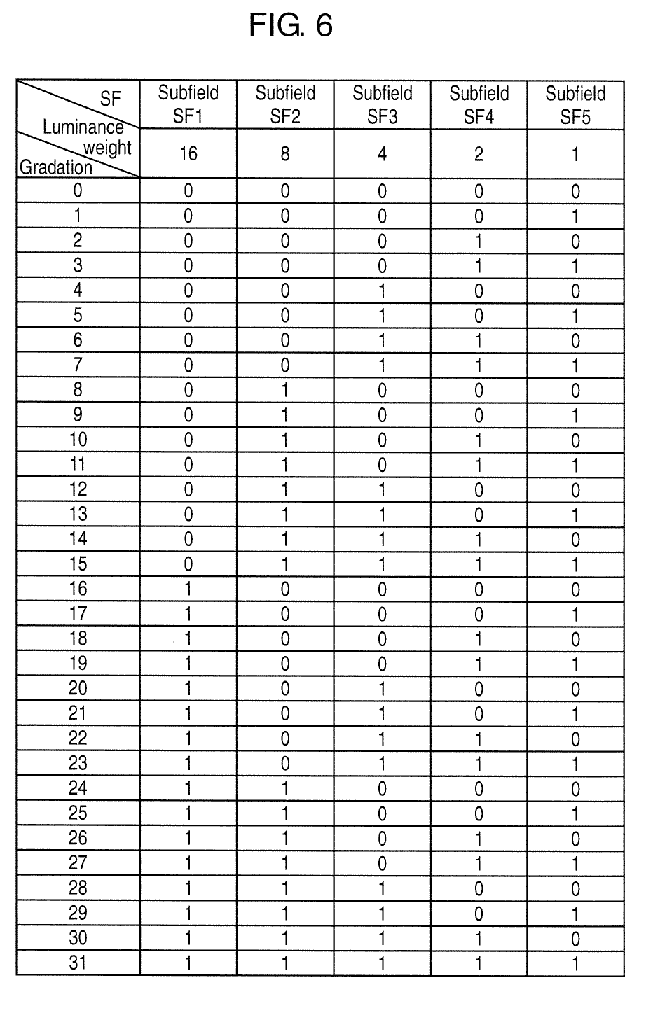

FIG. 6 is a table showing one example of a coding table serving as a base when displaying a 3D image in plasma display apparatus 40 according to the first embodiment of the invention. In FIG. 6, numerals representing gradation values are shown on the extreme left, and image data corresponding to each of the gradation values are shown on the right side of the gradation value. The image data are ones that represent performing/non-performing of address operation in each subfield. In FIG. 6, the performing of address operation is represented by “1”, and the non-performing of address operation is represented by “0”.

In accordance with the coding table shown in FIG. 6, for example, no address operation is performed in the discharge cell that represents a gradation value of “0”, in all the subfields of subfield SF1 to subfield SF5. Thereby, the discharge cell does not undergo any sustain discharge, which displays the gradation value of “0” of the smallest luminance. In the discharge cell representing a gradation value of “1”, for example, address operation is performed only in subfield SF5 that is one having a luminance weight of “1”, in the other subfields, no address operation is performed. Thereby, in the discharge cell, sustain discharges occur with the number of the discharges according to the luminance weight of “1”, generating light-emission at brightness corresponding to the gradation value of “1”, which displays the gradation value of “1”.

In the discharge cell displaying a gradation value of “7”, for example, address operation is performed in subfield SF3 with a luminance weight of “4”, subfield SF4 with a luminance weight of “2”, and subfield SF5 with a luminance weight of “1”, and no address operation is performed in the other subfields. Thereby, in the discharge cell, sustain discharges occur with the number of the discharges according to the luminance weight of “7”, generating light-emission at brightness corresponding to the gradation value of “7”, which displays the gradation value of “7”. Similarly, for the other gradation values, address operation is controlled in each of the subfields in accordance with the coding table shown in FIG. 6.

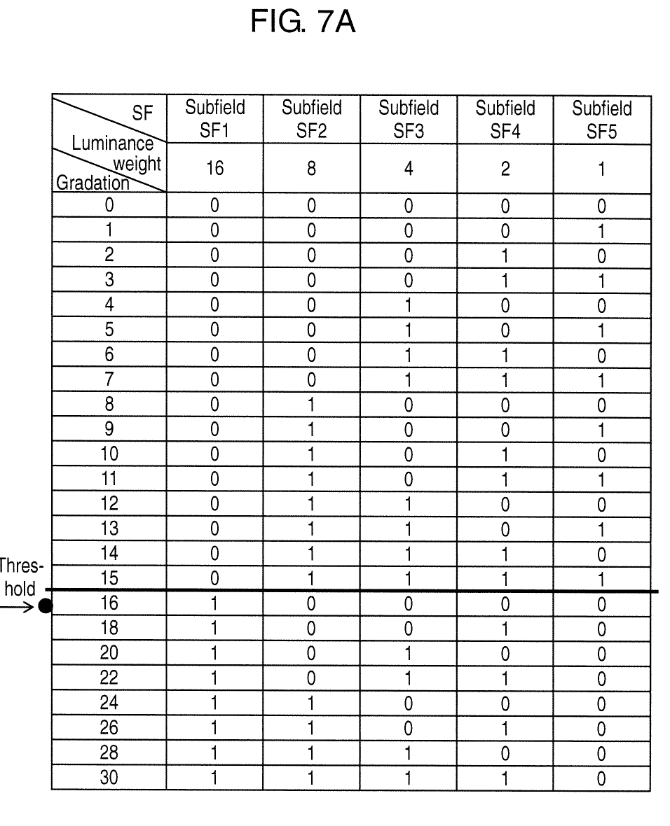

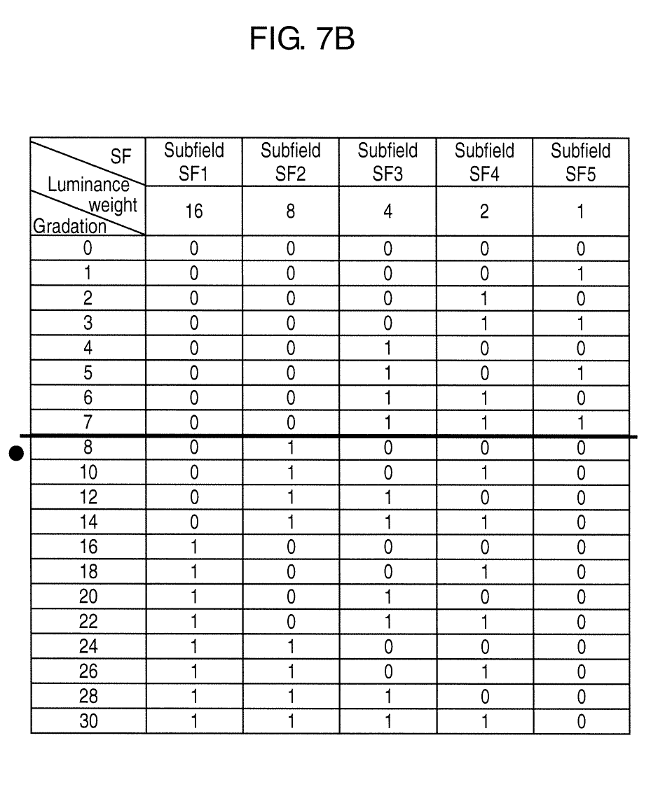

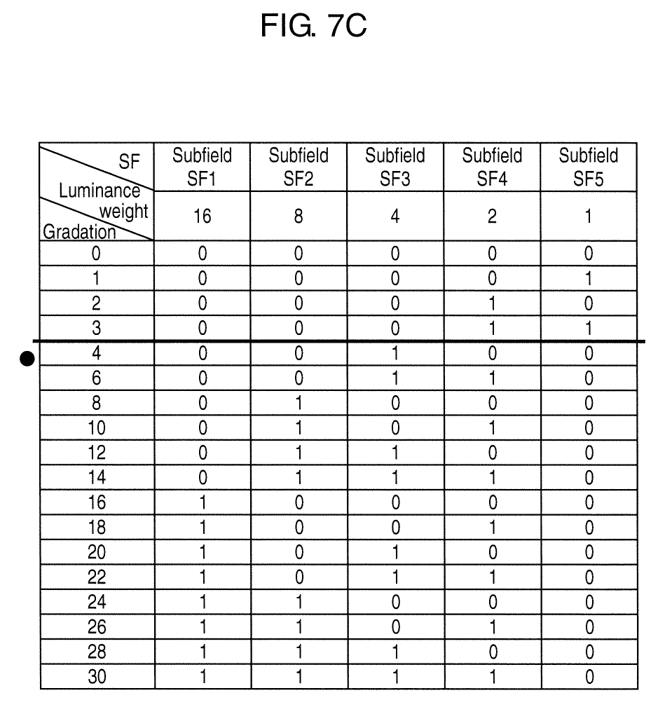

Next, a description is made regarding a coding table when a gradation is displayed in the discharge cell that is easy to generate an after-image, with reference to FIGS. 7A, 7B, and 7C.

FIG. 7A is a table showing one example of the coding table used when displaying a 3D image in plasma display apparatus 40 according to the first embodiment of the invention. FIG. 7B is a table showing another example of the coding table used when displaying a 3D image in plasma display apparatus 40 according to the first embodiment of the invention. FIG. 7C is a table showing further another example of the coding table used when displaying a 3D image in plasma display apparatus 40 according to the first embodiment of the invention.

In FIGS. 7A, 7B, and 7C, numerals representing gradation values are shown on the extreme left, and image data corresponding to each of the gradation values are shown on the right side of the gradation value. The image data are ones that represent performing/non-performing of address operation in each subfield. In FIGS. 7A, 7B, and 7C, the performing of address operation is represented by “1”, and the non-performing of address operation is represented by “0”.

Each of the coding tables shown in FIGS. 7A, 7B, and 7C is basically the same as that shown in FIG. 6. However, the coding tables shown in FIGS. 7A, 7B, and 7C are different in the following point from that shown in FIG. 6. That is, in the coding tables shown in FIGS. 7A, 7B, and 7C, when displaying a gradation value not smaller than the gradation value that is predetermined as a threshold, no address operation is performed in the last subfield of a field (subfield SF5, in the embodiment). In other words, when displaying the gradation values not smaller than the threshold, address operation is prohibited in the last subfield to cause the last subfield to be in non-lighting. In further other words, when displaying the gradation values not smaller than the threshold, the gradations where the last subfield is in non-lighting are exclusively used as gradations for display.

For example, in the coding table shown in FIG. 7A, a gradation value of “16” is set as a threshold. Therefore, when displaying gradation values not smaller than the gradation of “16” that is set as the threshold, no address operation is performed in subfield SF5, i.e. the last subfield.

In the coding table shown in FIG. 7B, a gradation value of “8” is set as a threshold. Therefore, when displaying gradation values not smaller than the gradation of “8” that is set as the threshold, no address operation is performed in subfield SF5, i.e. the last subfield.

In the coding table shown in FIG. 7C, a gradation value of “4” is set as a threshold. Therefore, when displaying gradation values not smaller than the gradation of “4” that is set as the threshold, no address operation is performed in subfield SF5, i.e. the last subfield.

As described above, in order to reduce the crosstalk by decreasing afterglow leaking from one field into the subsequent one, it is preferable to set the last subfield of the one field to have a small luminance weight, which allows the lowest possible amount of the afterglow leaking into the subsequent field.

Unless the last subfield causes light-emission to occur, no afterglow is caused in the last subfield. In addition, during the last subfield, afterglow having occurred accompanying the preceding light-emission decreases. Accordingly, unless the last subfield causes light-emission to occur, it is possible to further decrease the afterglow leaking into the subsequent field, permitting a further reduction of the crosstalk.

Therefore, the coding tables shown in FIGS. 7A, 7B, and 7C are ones with which the crosstalk is harder to occur than that with the coding table shown in FIG. 6.

In the embodiment, the last subfield of one field is set to a subfield that has the smallest luminance weight. Therefore, an influence of the last subfield on the displayed image is small compared with that of the other subfields. Even if the last subfield is set to be in non-lighting, the influence on the displayed image is relatively small.

This also is one of the reasons for the setting in which no address operation is performed in the last subfield of a field when displaying a gradation value not smaller than the gradation value set as a threshold in each of the coding tables shown in FIGS. 7A, 7B, and 7C.

In the coding table shown in FIG. 7A, for gradation values not smaller than the gradation value of “16” set as a threshold, subfield SF5 is set to be in non-lighting. For this reason, gradation values such as a gradation value of “17”, a gradation value of “19”, and a gradation value of “21”, for example, are not set in the coding table; therefore, these gradation values cannot be displayed on panel 10.

In the coding table shown in FIG. 7B, for gradation values not smaller than the gradation value of “8” set as a threshold, subfield SF5 is set to be in non-lighting. For this reason, in addition to the gradation values not set in the coding table shown in FIG. 7A, gradation values such as a gradation value of “9”, a gradation value of “11”, and a gradation value of “13”, for example, are not set in the coding table; therefore, these gradation values cannot be displayed on panel 10.

In the coding table shown in FIG. 7C, for gradation values not smaller than the gradation value of “4” set as a threshold, subfield SF5 is set to be in non-lighting. For this reason, in addition to the gradation values not set in the coding table shown in FIG. 7B, gradation values such as a gradation value of “5” and a gradation value of “7”, for example, are not set in the coding table; therefore, these gradation values cannot be displayed on panel 10.

However, these gradation values not set in the coding tables can be displayed on panel 10 in a pseudo manner, using a commonly-known method, for example, an error diffusion method or a dither method.

Next, a description is made as to when there is used the coding table (the coding table shown in FIG. 7A, 7B, or 7C) where a gradation value is set as a threshold, and as to when there is used the basic coding table (the coding table shown in FIG. 6), in the embodiment.

In this embodiment, two temporally consecutive fields are designated as a first field and a second field. The field occurring temporally earlier is the first field, and the field occurring temporally later is the second field. Therefore, when the first field is the field for right-eye displaying an image signal for right-eye, the second field is then the field for left-eye displaying an image signal for left-eye. And, when the first field is the field for left-eye, the second field is then the field for right-eye.

However, in the embodiment, each of the first field and the second field is not fixed. In the embodiment, the first field and the second field are determined based on fields displayed on panel 10. For example, if the first field is the field for right-eye and the second field is the field for left-eye when a field is displayed on panel 10, the first field is the field for left-eye and the second field is the field for right-eye when the subsequent field is displayed on panel 10.

In the embodiment, the image signal for the first field is converted into image data for use in displaying a gradation. In this situation, in the embodiment, when setting image data for a discharge cell, a coding table in which the threshold described above has been set is selected in accordance with image signals of the two temporally consecutive fields, and the image data are set for the discharge cell in accordance with the coding table. A description is made regarding the operation of converting the image signal of the first field into the image data.

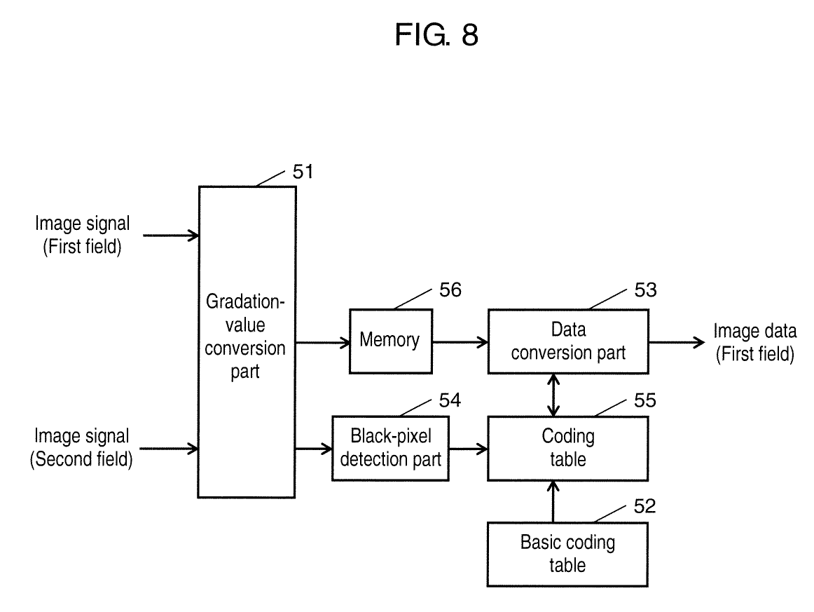

FIG. 8 is a diagram schematically showing a part of image signal processing circuit 41 used in plasma display apparatus 40 according to the first embodiment of the invention.

Image signal processing circuit 41 includes gradation-value conversion part 51, basic coding table 52, data conversion part 53, black-pixel detection part 54, coding table 55, and memory 56.

Gradation-value conversion part 51 converts the respective primary color signals of an input image signal (an image signal for right-eye or an image signal for left-eye, when being a 3D image signal) into a gradation value. Gradation-value conversion part 51 is fed with image signals of the first field and the consecutive second field (the image signals being the primary color signals corresponding respectively to red discharge cells (R-cells), green discharge cells (G-cells), and blue discharge cells (B-cells)). Then, the conversion part performs an image processing of the image signal of the first field, such as a gamma-correction and a number-of-pixel conversion in accordance with the number of pixels of panel 10, which are necessary for displaying the image on panel 10. Then, the conversion part converts the thus image-processed signal (the primary color signal) into a signal representing the gradation value, and outputs the converted signal. Also, the conversion part converts the image signal of the second field into a signal representing the gradation value, and outputs the converted signal.

Basic coding table 52 stores the coding table, serving as a base, shown in FIG. 6. That is, the basic coding table stores the gradation values and the image data corresponding to the respective gradation values shown in the coding table of FIG. 6.

Black-pixel detection part 54 compares the gradation value of the image signal of the second field output from gradation-value conversion part 51 with a predetermined comparison value. Then, if the gradation value is not larger than the comparison value, a determination of “black pixel” is made. For example, in the case where the comparison value is set equal to be a gradation value of “0”, black-pixel detection part 54 determines whether or not the gradation value of the image signal of the second field output from gradation-value conversion part 51 is the gradation value of “0”. Then, if the gradation value is a gradation value of “0”, the detection part makes a determination of “black pixel”. This determination is made for each of the discharge cells; therefore, black-pixel detection part 54 performs the determination of whether or not each of the discharge cells is involved in “black pixel” in accordance with the gradation value of the second field.

The magnitude of the comparison value for the determination of “black pixel” described above is nothing more than an example in the embodiment. The magnitude of the comparison value for determining “black pixel” is preferably appropriately set based on characteristics of panel 10, specifications of plasma display apparatus 40, and the like.

The result of the determination in black-pixel detection part 54 is output to coding table 55.

Coding table 55 determines the coding table to be used in the discharge cell corresponding to the gradation value of the first field output from gradation-value conversion part 51, based on the coding table stored in basic coding table 52 and the result of the determination in black-pixel detection part 54. It is an example of the coding table that is the coding tables shown in FIGS. 6, 7A, 7B, and 7C.

Memory 56 stores the gradation value corresponding to the image signal of the first field output from gradation-value conversion part 51 for a predetermined period of time, and then outputs the gradation value after delaying for the predetermined period. As described above, the first field and the second field are temporally consecutive, and the first field occurs earlier. Therefore, memory 56 outputs, after the temporal delay, the gradation value corresponding to the image signal of the first field such that posterior data conversion part 53 can, at the same timing, receive the following two inputs, i.e. the gradation value corresponding to the image signal of the first field and the coding table determined in coding table 55 in accordance with the gradation value of the second field. It is the length of the delay time that is the predetermined period of time.

Then, based on the gradation value corresponding to the image signal of the first field output from memory 56, from the coding table (e.g. the coding table shown in FIG. 6, 7A, 7B, or 7C) in coding table 55, data conversion part 53 retrieves the image data corresponding to the gradation value, and then outputs the thus-retrieved data as image data. Therefore, the image data output from data conversion part 53 is the image data of the first field.

Next, a description is made regarding the reason why, in the embodiment, the threshold described above is determined in the coding table for use in the discharge cell corresponding to the gradation value of the first field output from gradation-value conversion part 51, based on the determination in black-pixel detection part 54.

An after-image becomes easy to be seen by a user when a field displaying a dark image occurs immediately after a field displaying a light image has occurred. Accordingly, the after-image is easy to be seen by the user in the discharge cell in which the gradation value of an image signal of the second field is determined as “black pixel” in black-pixel detection part 54, compared to that in the discharge cell in which the gradation value of an image signal of the second field is determined as not “black pixel” in black-pixel detection part 54.

Therefore, when setting image data for such the discharge cell, it is more preferable to use the coding table shown in FIG. 7A, 7B, or 7C, which is hard to cause the crosstalk, than to use the coding table shown in FIG. 6. This is the reason for setting the image data using the coding table (the coding table shown in FIG. 7A, 7B, or 7C) in which the gradation value serving as a threshold is set, in the discharge cell where the gradation value of the image signal of the second field is determined as “black pixel” in black-pixel detection part 54.

On the other hand, the after-image is hard to be seen by the user in the discharge cell in which the gradation value of the image signal of the second field is determined as not “black pixel” in black-pixel detection part 54, compared to that in the discharge cell in which the gradation value of the image signal of the second field is determined as “black pixel” in black-pixel detection part 54. Therefore, when setting image data for such the discharge cell, the table (e.g. the coding table shown in FIG. 6) serving as a base is used which includes the relatively large number of gradation values usable for the displaying.

In this way, in the embodiment, black-pixel detection part 54 determines whether or not the gradation value of the image signal of the second field is “black pixel”. If determined as not “black pixel”, the gradation value of the first field is converted into image data in accordance with the coding table (e.g. the coding table shown in FIG. 6) serving as a base. If determined as “black pixel”, the gradation value of the first field is converted into image data in accordance with the coding table (e.g. the coding table shown in FIG. 7A, 7B, or 7C) in which a threshold is set and address operation for gradation values not smaller than the threshold is prohibited in the last subfield. With this configuration, the crosstalk is suppressed and the quality of displaying a 3D image is improved.

As described above, in the plasma display apparatus according to the embodiment, when displaying a 3D image signal on panel 10, the subfield having the largest luminance weight is generated at the first of a field, each of the subsequently generated subfields is set to have a sequentially decreasing luminance weight in ascending order of the subfields, and the subfield having the smallest luminance weight is generated at the last of the field. This allows a reduction of crosstalk from an image for right-eye to an image for left-eye and crosstalk from an image for left-eye to an image for right-eye.

In the plasma display apparatus according to the embodiment, when displaying a 3D image signal on panel 10, black-pixel detection part 54 determines whether or not the gradation value of the image signal of the second field is “black pixel”, and then the coding table is changed based on the determination (changed from the coding table serving as a base to the coding table where a threshold is set). This allows a further reduction of the afterglow leaking into the subsequent field and a further reduction of the crosstalk.

With the configurations described above, the plasma display apparatus shown in the embodiment is capable of providing the user with a high-quality 3D image, with the user viewing a 3D image through a pair of shutter glasses 48.

Ease with which the after-image occurs is different between in the discharge cells using a phosphor (a long afterglow phosphor) with large time constants of afterglow and in the discharge cells using a phosphor (a short afterglow phosphor) with small time constants of afterglow. That is, the crosstalk is easy to occur in the discharge cell using a long afterglow phosphor having relatively large time constants of afterglow, compared to in the discharge cell using a short afterglow phosphor.

Hence, the configuration may be as follows. That is, only for the discharge cells using a long afterglow phosphor, the operation described above is performed in such a way that: black-pixel detection part 54 determines whether the gradation values of the image signal of the second field are “black pixel”, and then the coding table is changed based on the determination. And, for the discharge cells using a short afterglow phosphor, the coding table shown in FIG. 6 serving as a base is used.

The above-described time constant of afterglow is the measured value of a period of time that is required for luminance of light-emission to decay to 10% of the maximum luminance after completion of a sustain discharge, where the maximum luminance of light-emission caused by the sustain discharge is set to 100%. For example, it may be configured that a phosphor with time constants of afterglow smaller than 1 msec is the short afterglow phosphor and that a phosphor with time constants of afterglow not smaller than 1 msec is the long afterglow phosphor. In panel 10 shown in the embodiment, phosphor layer 35G and phosphor layer 35R use the long afterglow phosphors with time constants of afterglow of approximately 2 msec to 3 msec, and phosphor layer 35B uses the short afterglow phosphor with a time constant of afterglow of approximately 0.1 msec. Hence, the configuration may be as follows. That is, for the green discharge cells having phosphor layers 35G and the red discharge cells having phosphor layers 35R, black-pixel detection part 54 determines whether the gradation values of the image signal of the second field are “black pixel”, and then the coding table shown in FIG. 7A, 7B, or 7C is used based on the determination. And, for the blue discharge cells having phosphor layers 35B, the coding table shown in FIG. 6 serving as a base is used.

However, in the present invention, the time constants of afterglow that discriminate between long afterglow phosphors and short afterglow phosphors are not limited to the numerical values described above, and that the phosphors used in phosphor layer 35R, phosphor layer 35G, and phosphor layer 35B are not limited to the phosphors with the time constants of afterglow described above.

In the embodiment, three exemplified coding tables have been shown for illustrating an example of the gradation values serving as the thresholds, as follows. The coding table shown in FIG. 7A has been exemplified in which the threshold is set to a gradation value of “16”, and no address operation is performed in the last subfield SF5 when displaying gradation values not smaller than the gradation value of “16”. The coding table shown in FIG. 7B has been exemplified in which the threshold is set to a gradation value of “8”, and no address operation is performed in the last subfield SF5 when displaying gradation values not smaller than the gradation value of “8”. And, the coding table shown in FIG. 7C has been exemplified in which the threshold is set to a gradation value of “4”, and no address operation is performed in the last subfield SF5 when displaying gradation values not smaller than the gradation value of “4”. It is preferable that the determination of which of the coding tables is to be used in coding table 55 be made appropriately based on the characteristics of panel 10 and the specifications of plasma display apparatus 40. The gradation values serving as the thresholds described above are nothing more than an exemplary embodiment; therefore, the setting of the gradation values serving as thresholds is preferably appropriately made based on the characteristics of panel 10 and the specifications of plasma display apparatus 40.

For example, when displaying a gradation value not set in the coding table on panel 10 in a pseudo manner using an error diffusion method or a dither method, fine dot-like noise sometimes appears in the image displayed on panel 10. The fine dot-like noise becomes easy to occur as the number of the gradation values not set in the coding table increases. The fine dot-like noise is easier to be seen by the user when displaying an image of low gradations than when displaying an image of high gradations. Accordingly, the fine dot-like noise is easier to occur when displaying an image using the coding table shown in FIG. 7B than when displaying the image using the coding table shown in FIG. 7A, and easier to occur when displaying an image using the coding table shown in FIG. 7C than when displaying the image using the coding table shown in FIG. 7B. Hence, taking these into consideration, the configuration may be such that the gradation value serving as a threshold is adaptively changed in response to the displayed image in such a way as follows. That is, a determination is made whether the noise is distinct in the image, based on the luminance of the displayed image and the like. Then, based on the determination, the gradation value serving as a threshold is, for example, decreased when the displayed image is bright, compared to when the displayed image is dark.

In the embodiment, the description has been made of the configuration in which each of the subfields configuring one field is set to have a sequentially decreasing luminance weight in temporal order of generation of the subfields such that the later each of the subfields is generated, the smaller the luminance weight of the subfield is. However, the present invention is not limited to the configuration. For example, even if there is no relationship between the luminance weights and the temporal order of generation of the subfields, it is possible to achieve the effect of suppressing the crosstalk by using a coding table with which no address operation is performed in the last subfield.

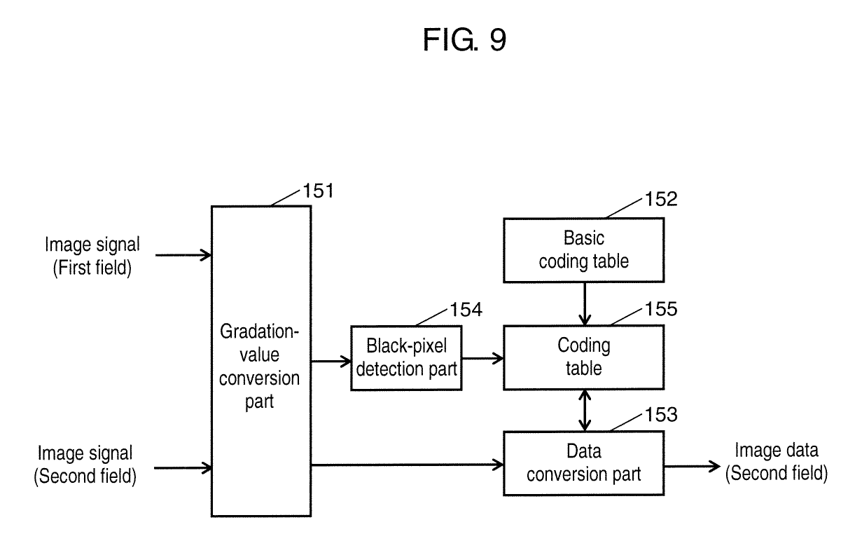

Although not shown in FIGS. 8 and 9, image signal processing circuit 41 includes a circuit for displaying gradation values not set in coding tables on panel 10, in a pseudo manner, using a commonly-known method such as an error diffusion method and a dither method.

Further, in the embodiment, in 3D-driving, timing-signal generation circuit 45 may generate the shutter opening/closing timing signal such that the shutter for right-eye and the shutter for left-eye are both in a closed state in the initializing period of the first subfield.

### Second Exemplary Embodiment

In this embodiment, a description is made regarding image signal processing circuit 141 that has a configuration different from that of image signal processing circuit 41 shown in the first embodiment.

In the following description, it is assumed that each of the fields occurs in the order of field F1, field F2, field F3, field F4 . . . . For easy understanding of the description, field F1 is designated as the first field, field F2 as the second field, field F3 as the first field, and field F4 as the second field.

However, in the embodiment, each of the first field and the second field is not fixed. For example, an odd-numbered field is not designated as the first field and an even-numbered field is not designated as the second field. In the embodiment, the first field and the second field are determined based on fields displayed on panel 10. For example, if the first field is field F1 and the second field is field F2 when a field is displayed on panel 10, the first field is field F2 and the second field is field F3 when the subsequent field is displayed on panel 10.

In the first embodiment, the configuration has been described in which the gradation value of the image signal of the second field is determined whether the gradation value is “black pixel”, in black-pixel detection part 54. In this embodiment, however, the gradation value of the image signal of the first field is determined whether the gradation value is “black pixel”, in black-pixel detection part 54. Then, based on the determination, the coding table is determined which is to be used in converting the gradation value of the image signal of the second field into the image data.

It is thought that two temporally consecutive 3D images have a high correlation of image signals therebetween. That is, a high correlation of image signal can be expected between the field for right-eye (e.g. field F1) displaying the image signal for right-eye in one 3D image and the field for right-eye (e.g. field F3) displaying the image signal for right-eye in the immediately subsequent 3D image, and be expected between the field for left-eye (e.g. field F2) displaying the image signal for left-eye in one 3D image and the field for left-eye (e.g. field F4) displaying the image signal for left-eye in the immediately subsequent 3D image.

Therefore, in the discharge cell in which the gradation value of the first field (field F1) has been determined to be “black pixel” in black-pixel detection part 54, it is highly likely that the gradation value of the subsequent first field (field F3) would be determined to be “black pixel”.

Then, when displaying a 3D image on panel 10 in accordance with a 3D image signal, the field for right-eye and the field for left-eye occur in a temporally alternately repeated manner. Accordingly, in the discharge cell in which a “black pixel” determination has been made in the first field (field F1), even if a “black pixel” determination is not made in the second field (field F2) immediately subsequent to the first field (field F1), it is highly likely that a “black pixel” determination would be made in the first field (field F3) subsequent to the second field (field F2).

That is, in the discharge cell in which a “black pixel” determination has been made in the first field (field F1), a “black pixel” determination is expected to be made in the subsequent first field (field F3) as well. Therefore, when converting the gradation value of the image signal of the second field (field F2) into image data, it is preferable to use the coding table (e.g. the coding table shown in FIG. 7A, 7B, or 7C) in which address operation for gradation values not smaller than a threshold is prohibited in the last subfield. With this configuration, it is possible to suppress the crosstalk from the second field (field F2) into the subsequent first field (field F3).

On the other hand, in the discharge cell in which the gradation value of the first field (field F1) has been determined to be not “black pixel”, it is expected that the gradation value of the subsequent first field (field F3) is also determined to be not “black pixel”. Therefore, it is thought that the after-image from the second field (field F2) into the subsequent first field (field F3) is relatively hard to be seen by the user. Accordingly, in such the case, when converting the gradation value of the image signal of the second field (field F2) into image data, the coding table (e.g. the coding table shown in FIG. 6) serving as a base is used which includes the relatively large number of gradation values usable for the displaying.

FIG. 9 is a diagram schematically showing a part of image signal processing circuit 141 used in the plasma display apparatus according to the second embodiment of the present invention.

Signal processing circuit 141 includes gradation-value conversion part 151, basic coding table 152, data conversion part 153, black-pixel detection part 154, and coding table 155.

Gradation-value conversion part 151 converts the respective primary color signals of an input image signal (an image signal for right-eye or an image signal for left-eye, when being a 3D image signal) into a gradation value. Gradation-value conversion part 151 is fed with the image signals of the first field and the consecutive second field (the image signals being the primary color signals corresponding respectively to red discharge cells (R-cells), green discharge cells (G-cells), and blue discharge cells (B-cells)). Then, the conversion part performs an image processing of the image signal of the second field, such as a gamma-correction and a number-of-pixel conversion in accordance with the number of pixels of panel 10, which are necessary for displaying the image on panel 10. Then, the conversion part converts the thus image-processed signal (the primary color signal) into a signal representing the gradation value, and outputs the converted signal. Also, the conversion part converts the image signal of the first field into a signal representing the gradation value, and outputs the converted signal.

Basic coding table 152 stores the coding table, serving as a base, shown in FIG. 6. That is, the basic coding table stores the gradation values and the image data corresponding to the respective gradation values shown in the coding table of FIG. 6.

Black-pixel detection part 154 compares the gradation value of the image signal of the first field output from gradation-value conversion part 151 with a predetermined comparison value. Then, if the compared gradation value is not larger than the comparison value, a determination of “black pixel” is made. For example, in the case where the comparison value is set equal to be a gradation value of “0”, black-pixel detection part 154 determines whether or not the compared gradation value of the image signal of the first field output from gradation-value conversion part 151 is the gradation value of “0”. Then, if the compared gradation value is a gradation value of “0”, the detection part makes a determination of “black pixel”. This determination is made for each of the discharge cells; therefore, black-pixel detection part 154 performs the determination of whether or not each of the discharge cells is involved in “black pixel” in accordance with the gradation value of the first field.

The magnitude of the comparison value for determining “black pixel” described above is nothing more than an example in the embodiment. The magnitude of the comparison value for determining “black pixel” is preferably appropriately set based on the characteristics of panel 10, the specifications of plasma display apparatus 40, and the like.

The result of the determination in black-pixel detection part 154 is output to coding table 155.

Coding table 155 determines the coding table to be used in the discharge cell corresponding to the gradation value of the second field output from gradation-value conversion part 151, based on the coding table stored in basic coding table 152 and the result of the determination in black-pixel detection part 154. It is an example of the coding table that is the coding tables shown in FIGS. 6, 7A, 7B, and 7C.

Then, based on the gradation value of the second field output from gradation-value conversion part 151, from the coding table (e.g. the coding table shown in FIG. 6, 7A, 7B, or 7C) in coding table 155, data conversion part 153 retrieves the image data corresponding to the gradation value, and then outputs the thus-retrieved data as image data. Therefore, the image data output from data conversion part 153 is the image data of the second field. And, the coding table shown in FIG. 7A, 7B, or 7C is one in which address operation is prohibited in the last subfield (subfield SF5 in the case of the embodiment) for gradation values not smaller than the gradation value set as a threshold.

As described above, in the embodiment, from the determination of whether the gradation value of the first field (field F1) is “black pixel”, a determination is presumed of whether the gradation value of the subsequent first field (field F3) is “black pixel”. Then, based on the presumption, a coding table is set which is to be used in converting the gradation values of the image signal of the second field (field F2) into image data.

This allows a reduction in afterglow leaking into the subsequent field to suppress the crosstalk when displaying an image expected to cause the after-image, which thereby provides the user with the 3D image of high-quality, with the user viewing a 3D image through a pair of shutter glasses 48.

With the configuration of image signal processing circuit 141 shown in FIG. 9, memory 56 can be eliminated in comparison with the configuration of image signal processing circuit 41 shown in FIG. 8.

In the first embodiment and the second embodiment, the descriptions have been made of the configurations in which luminance weights are set for each of the subfields, in the field for right-eye and the field for the left-eye, as follows. That is, the first subfield of each of the fields is set to have the largest luminance weight, and each of the second subfield and subsequent ones is set to have a sequentially decreasing luminance weight in ascending order of the subfields. In the present invention, however, the luminance weight of each of the subfields configuring one field is not limited to such the configurations.

For example, the luminance weight may be set for each of the subfields as follows. That is, in the field for right-eye and the field for the left-eye, the subfield occurring at the first of each the field is set to have the smallest luminance weight, the second subfield is set to have the largest luminance weight, and each of the third subfield (the subfield occurring at the third of a field) and subsequent ones is set to have a sequentially decreasing luminance weight in ascending order of the subfields. With this configuration, it is possible to reduce the crosstalk by decreasing the amount of the afterglow leaking into the subsequent field, and concurrently to stabilize the address operation in the subsequent subfields by increasing the number of discharge cells in which the wall charge and priming particles are replenished by the sustain discharge occurring in the sustain period of subfield SF1.

The coding used in plasma display apparatus 40 and the gradation values displayed on panel 10 are not limited to the coding shown in FIGS. 6, 7A, 7B, and 7C. The gradation values to be displayed on panel 10 and the combination of light-emission and no light-emission for each subfield may be set based on the specifications or the like of plasma display apparatus 40.

In the first embodiment and the second embodiment, the descriptions have been made of the example in which one field is configured with five subfields. In the present invention, however, the number of subfields configuring one field is not limited to the numerals described above. For example, it is possible to further increase the number of gradations capable of being displayed on panel 10 by increasing the number of the subfields to be larger than five.

In the first embodiment and the second embodiment, the descriptions have been made of the example in which each of the luminance weights of the subfields is set to be a power of two, in such a way that the luminance weights of subfield SF1 to subfield SF5 are respectively (16, 8, 4, 2, and 1). However, that the luminance weights set for the respective subfields are not limited to the numerals described above. For example, a coding is possible which suppresses occurrence of false contours in a moving image by giving a redundancy to the combination of subfields that determines gradations, in such a way that the luminance weights of the subfields are respectively set to (12, 7, 3, 2, and 1,) or the like. The number of subfields configuring one field, the luminance weight of each subfield, and the like may be appropriately set based on the characteristics of panel 10 and the specifications of plasma display apparatus 40.

In the embodiments, the descriptions have been made of the configurations in which phosphor layer 35R and phosphor layer 35G use the long afterglow phosphors with time constants of approximately 2 msec to 3 msec, and phosphor layer 35B uses the short afterglow phosphor with a time constant of approximately 0.1 msec. However, the present invention is not limited to the configurations. For example, the configurations may be such that phosphor layer 35G and phosphor layer 35B use long afterglow phosphors, and phosphor layer 35R uses a short afterglow phosphor. Alternatively, the configurations may be such that phosphor layer 35R and phosphor layer 35B use long afterglow phosphors, and phosphor layer 35G uses a short afterglow phosphor. Further alternatively, the configurations may be such that any one of phosphor layer 35R, phosphor layer 35G, and phosphor layer 35B uses a long afterglow phosphor, and the other two layers use short afterglow phosphors.

The driving voltage waveforms shown in FIGS. 4 and 5 are nothing more than an example in the embodiments of the present invention, and that the present invention is not limited to these driving voltage waveforms. The circuit configurations shown in FIGS. 3, 8, and 9 are nothing more than an example in the embodiments of the present invention, and the present invention is not limited to the circuit configurations.

In FIG. 5, the example has been shown in which, in a time period after finishing subfield SF5 and before starting subfield SF1, the down-ramp waveform voltage is generated and applied to scan electrode SC1 to scan electrode SCn, and voltage Ve1 is applied to sustain electrode SU1 to sustain electrode SUn. However, these voltages are not necessary to be generated. For example, in the time period after finishing subfield SF5 and before starting subfield SF1, the configuration may be such that zero (V) is held at all of scan electrode SC1 to scan electrode SCn, sustain electrode SU1 to sustain electrode SUn, and data electrode D1 to data electrode Dm.

Each of the circuit blocks shown in the embodiments of the present invention may be configured as an electric circuit performing each the operation shown in the embodiments, or may alternatively be configured using such as a microcomputer that is programmed to perform the same operation.

In the embodiments, the descriptions have been made of the configurations using the example in which one pixel is configured with the discharge cells each having three colors of R, G, and B. However, it is possible to employ the configurations shown in the embodiments even for a panel in which one pixel is configured with the discharge cells each having four or more colors, which provides the same advantages.

The specific numerical values shown in the embodiments of the present invention are set based on the characteristics of panel 10 with a screen size of 50 inches and 1024 display electrode pairs 24, and these values are nothing more than an example of the embodiments. The present invention is not limited to these specific numerical values, and each of these numerical values is preferably optimally set based on characteristics of a panel, specifications of a plasma display apparatus, and the like. Variations are allowed for each of these numerical values within a range in which the advantages described above are held. The number of subfields configuring one field, the luminance weight of each subfield, and the like are not limited to the values shown in the embodiments of the present invention, and the configuration of the subfields may be one that is switched over in accordance with the image signal and the like.

### INDUSTRIAL APPLICABILITY

The present invention is capable of reducing crosstalk that occurs between an image for right-eye and an image for left-eye, which thereby provides a high-quality stereoscopic image for a user viewing a displayed image through a pair of shutter glasses, in a plasma display apparatus usable as a stereoscopic-image display apparatus. Hence, the present invention is useful for a driving method of a plasma display apparatus, a plasma display apparatus, and a plasma display system.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35, 35R, 35G, 35B phosphor layer
40 plasma display apparatus
41, 141 image signal processing circuit
42 data electrode driver circuit
43 scan electrode driver circuit
44 sustain electrode driver circuit
45 timing-signal generation circuit
46 timing-signal output part
48 shutter glasses
49R right-eye shutter
49L left-eye shutter
51, 151 gradation-value conversion part
52, 152 basic coding table
53, 153 data conversion part
54, 154 black-pixel detection part
55, 155 coding table
56 memory

1. A method for driving a plasma display apparatus that includes:
a plasma display panel in which a plurality of discharge cells is arranged, each of the discharge cells having a scan electrode, a sustain electrode, and a data electrode; and
a driver circuit for driving the plasma display panel, wherein the plasma display apparatus displays an image on the plasma display panel such that:
one field is formed of a plurality of subfields each of which has an address period for performing an address operation by generating an address discharge in each of the discharge cells in response to an image signal, and a sustain period for generating sustain discharges in number corresponding to a luminance weight in discharge cells in which the address discharge has been generated,
image data are set based on the image signal for indicating a light-emission or no light-emission of the respective subfields, and
a field for right-eye for displaying an image signal for right-eye and a field for left-eye for displaying an image signal for left-eye are alternately repeated for displaying an image on the plasma display panel based on the image signal including the image signal for right-eye and the image signal for left-eye,
the method for driving the plasma display apparatus comprising:
wherein, in a first field and a second field, the first and second fields being temporally consecutive, for a discharge cell displaying a gradation not larger than a predetermined comparison value in the occurring-temporally-later second field, when a gradation not smaller than a predetermined threshold is displayed in the occurring-temporally-earlier first field, setting an image data for prohibiting the address operation in a last-occurring subfield of the first field.

2. A method for driving a plasma display apparatus that includes:
a plasma display panel in which a plurality of discharge cells is arranged, each of the discharge cells having a scan electrode, a sustain electrode, and a data electrode; and
a driver circuit for driving the plasma display panel,
wherein the plasma display apparatus displays an image on the plasma display panel such that:
one field is formed of a plurality of subfields each of which has an address period for performing an address operation by generating an address discharge in each of the discharge cells in response to an image signal, and a sustain period for generating sustain discharges in number corresponding to a luminance weight in discharge cells in which the address discharge has been generated,
image data are set based on the image signal for indicating a light-emission or no light-emission of the respective subfields, and
a field for right-eye for displaying an image signal for right-eye and a field for left-eye for displaying an image signal for left-eye are alternately repeated for displaying an image on the plasma display panel based on the image signal including the image signal for right-eye and the image signal for left-eye,
the method for driving the plasma display apparatus comprising:
wherein, in a first field and a second field, the first and second fields being temporally consecutive,
for a discharge cell displaying a gradation not larger than a predetermined comparison value in the occurring-temporally-earlier first field, when a gradation not smaller than a predetermined threshold is displayed in the occurring-temporally-later second field, setting an image data for prohibiting the address operation in a last-occurring subfield of the second field.

3. The method for driving a plasma display apparatus of claim 1, wherein the comparison value is set equal to a gradation value “zero”.

4. The method for driving a plasma display apparatus of claim 1, wherein, of the plurality of discharge cells configuring one pixel, for the discharge cells having a phosphor with a longest afterglow time, the image data are set in accordance with a coding table where the threshold is set and, for the discharge cells having a phosphor with a shortest afterglow time, the image data are set in accordance with a coding table where the threshold is not set.

5. The method for driving a plasma display apparatus of claim 1, wherein, in the field for right-eye and the field for left-eye, a subfield occurring at a first of each the field is set as one having a largest luminance weight, a second-occurring subfield and subsequent ones of the each the field are each set to have a sequentially decreasing luminance weight in ascending order of the subfields, and a subfield occurring at an last of the each the field is set as one having a smallest luminance weight.

6. The method for driving a plasma display apparatus of claim 1, wherein, in the field for right-eye and the field for left-eye, a subfield occurring at a first of each the field is set as one having a smallest luminance weight, a second-occurring subfield of the each the field is set as one having a largest luminance weight, and a third-occurring subfield and subsequent ones of the each the field are each set to have a sequentially decreasing luminance weight in ascending order of the subfields.

7. The method for driving a plasma display apparatus of claim 1, wherein, a magnitude of the threshold is changed in response to a brightness of the image displayed on the plasma display panel such that the threshold is set smaller as the brightness of the image is larger.

8. A plasma display apparatus comprising:
a plasma display panel in which a plurality of discharge cells is arranged, each of the discharge cells having a scan electrode, a sustain electrode, and a data electrode; and
a driver circuit for driving the plasma display panel, the driver circuit displaying an image on the plasma display panel in a manner such that:
one field is formed of a plurality of subfields each of which has an address period for performing an address operation by generating an address discharge in each of the discharge cells in response to an image signal, and a sustain period for generating sustain discharges in number corresponding to a luminance weight in discharge cells in which the address discharge has been generated,
image data are set based on the image signal for indicating a light-emission or no light-emission of the respective subfields, and
a field for right-eye for displaying an image signal for right-eye and a field for left-eye for displaying an image signal for left-eye are alternately repeated for displaying an image on the plasma display panel based on the image signal including the image signal for right-eye and the image signal for left-eye,
wherein, in a first field and a second field, the first and second fields being temporally consecutive, for a discharge cell displaying a gradation not larger than a predetermined comparison value in the occurring-temporally-later second field, when displaying a gradation not smaller than a predetermined threshold in the occurring-temporally-earlier first field, the image data are set to prohibit the address operation in a last-occurring subfield of the first field.

9. A plasma display apparatus comprising:
a plasma display panel in which a plurality of discharge cells is arranged, each of the discharge cells having a scan electrode, a sustain electrode, and a data electrode; and
a driver circuit for driving the plasma display panel, the driver circuit displaying an image on the plasma display panel in a manner such that:
one field is formed of a plurality of subfields each of which has an address period for performing an address operation by generating an address discharge in each of the discharge cells in response to an image signal, and a sustain period for generating sustain discharges in number corresponding to a luminance weight in discharge cells in which the address discharge has been generated,
image data are set based on the image signal for indicating a light-emission or no light-emission of the respective subfields; and
a field for right-eye for displaying an image signal for right-eye and a field for left-eye for displaying an image signal for left-eye are alternately repeated for displaying an image on the plasma display panel based on the image signal including the image signal for right-eye and the image signal for left-eye,
wherein, in a first field and a second field, the first and second fields being temporally consecutive, for a discharge cell displaying a gradation not larger than a predetermined comparison value in the occurring-temporally-earlier first field, when displaying a gradation not smaller than a predetermined threshold in the occurring-temporally-later second field, the image data are set to prohibit the address operation in a last-occurring subfield of the second field.

10. A plasma display system comprising:
a plasma display apparatus including:
a plasma display panel in which a plurality of discharge cells is arranged, each of the discharge cells having a scan electrode, a sustain electrode, and a data electrode; and
a driver circuit for driving the plasma display panel, the driver circuit including a timing-signal output part outputting a shutter opening/closing timing signal in synchronization with a field for right-eye and a field for left-eye; and
a pair of shutter glasses including:
a right-eye shutter; and
a left-eye shutter, both the shutters being capable of being opened and closed, independently of each other, which is controlled by the shutter opening/closing timing signal,
the driver circuit displaying an image on the plasma display panel in a manner such that:
one field is formed of a plurality of subfields each of which has an address period for performing an address operation by generating an address discharge in each of the discharge cells in response to an image signal, and a sustain period for generating sustain discharges in number corresponding to a luminance weight in discharge cells in which the address discharge has been generated,
image data are set based on the image signal for indicating a light-emission or no light-emission of the respective subfields, and
the field for right-eye for displaying an image signal for right-eye and the field for left-eye for displaying an image signal for left-eye are alternately repeated for displaying an image on the plasma display panel based on the image signal including the image signal for right-eye and the image signal for left-eye,
wherein, in a first field and a second field, the first and second fields being temporally consecutive, for a discharge cell displaying a gradation not larger than a predetermined comparison value in the occurring-temporally-later second field, when displaying a gradation not smaller than a predetermined threshold in the occurring-temporally-earlier first field, the image data are set to prohibit the address operation in a last-occurring subfield of the first field.

11. A plasma display system comprising:
a plasma display apparatus including:
a plasma display panel in which a plurality of discharge cells is arranged, each of, the discharge cells having a scan electrode, a sustain electrode, and a data electrode; and
a driver circuit for driving the plasma display panel, the driver circuit including a timing-signal output part outputting a shutter opening/closing timing signal in synchronization with a field for right-eye and a field for left-eye; and
a pair of shutter glasses including:
a right-eye shutter; and
a left-eye shutter, both the shutters being capable of being opened and closed, independently of each other, which is controlled by the shutter opening/closing timing signal,
the driver circuit displaying an image on the plasma display panel in a manner such that:
one field is formed of a plurality of subfields each of which has an address period for performing an address operation by generating an address discharge in each of the discharge cells in response to an image signal, and a sustain period for generating sustain discharges in number corresponding to a luminance weight in discharge cells in which the address discharge has been generated,
image data are set based on the image signal for indicating a light-emission or no light-emission of the respective subfields, and
the field for right-eye for displaying an image signal for right-eye and the field for left-eye for displaying an image signal for left-eye are alternately repeated for displaying an image on the plasma display panel based on the image signal including the image signal for right-eye and the image signal for left-eye,
wherein, in a first field and a second field, the first and second fields being temporally consecutive, for a discharge cell displaying a gradation not larger than a predetermined comparison value in the occurring-temporally-earlier first field, when displaying a gradation not smaller than a predetermined threshold in the occurring-temporally-later second field, the image data are set to prohibit the address operation in a last-occurring subfield of the second field.

12. The method for driving a plasma display apparatus of claim 2, wherein the comparison value is set equal to a gradation value “zero”.

13. The method for driving a plasma display apparatus of claim 2, wherein, of the plurality of discharge cells configuring one pixel, for the discharge cells having a phosphor with a longest afterglow time, the image data are set in accordance with a coding table where the threshold is set and, for the discharge cells having a phosphor with a shortest afterglow time, the image data are set in accordance with a coding table where the threshold is not set.

14. The method for driving a plasma display apparatus of claim 2, wherein, in the field for right-eye and the field for left-eye, a subfield occurring at a first of each the field is set as one having a largest luminance weight, a second-occurring subfield and subsequent ones of the each the field are each set to have a sequentially decreasing luminance weight in ascending order of the subfields, and a subfield occurring at an last of the each the field is set as one having a smallest luminance weight.

15. The method for driving a plasma display apparatus of claim 2, wherein, in the field for right-eye and the field for left-eye, a subfield occurring at a first of each the field is set as one having a smallest luminance weight, a second-occurring subfield of the each the field is set as one having a largest luminance weight, and a third-occurring subfield and subsequent ones of the each the field are each set to have a sequentially decreasing luminance weight in ascending order of the subfields.

16. The method for driving a plasma display apparatus of claim 2, wherein, a magnitude of the threshold is changed in response to a brightness of the image displayed on the plasma display panel such that the threshold is set smaller as the brightness of the image is larger.
